(19) United States
(12) Patent Application Publication
(10) Pub. No.: US 2024/0116721 A1
(43) Pub. Date: Apr. 11, 2024

(54) SUPPORT FOR A SHEET OF GLASS

(71) Applicant: PILKINGTON GROUP LIMITED, Nr. Ormskirk Lancashire (GB)

(72) Inventors: John Stephen MASSA, Wigan Greater Manchester (GB); Ian Ross WILLIAMS, Wigan Lancashire (GB)

(73) Assignee: Pilkington Group Limited, Nr. Ormskirk Lancashire (GB)

(21) Appl. No.: 18/546,292

(22) PCT Filed: Feb. 18, 2022
(86) PCT No.: PCT/GB2022/050449

§ 371 Date: Aug. 14, 2023

(30) Foreign Application Priority Data
Feb. 19, 2021 (GB) 2102385.8

(51) Int. Cl. B65G 49/06

(52) U.S. Cl. CPC B65G 49/061; B65G 2203/0208

(57) ABSTRACT

A support for a sheet of glass is disclosed. The support comprises first and second support assemblies each comprising a respective base and arm assembly. Each arm assembly comprises a respective first arm having first and second ends and a first contact surface at each end thereof for contacting a first major surface of the sheet of glass when the sheet of glass is supported on the support. Each arm assembly is coupled to the respective base by a respective coupling for rotation about a pivot axis. Any of the first contact surfaces may be provided by a ball castor or wheel. The support is useful when supporting the glass sheet wherein a measurement of the shape thereof is required because the support is able to quickly reach an equilibrium configuration. A method of supporting a glass sheet using the support is also disclosed.

The present invention relates to a support for a sheet of glass, to a method of supporting a sheet of glass and to a method of determining the shape of a shaped sheet of glass supported on the support.

Many processes are known for shaping a sheet of flat glass, for example heating the sheet of glass to a suitably high temperature and allowing the sheet of glass to sag under gravity, or pressing a heat softened sheet of glass between complementary shaping members.

A support for hot glass sheets is described in FR3063286A1.

Whatever shaping process is used, the shape to be produced is usually selected beforehand and based upon a particular design. For example, when making a shaped sheet of glass for use as a vehicle glazing, a design may be provided by a vehicle manufacturer, and the design is often provided in the form of a CAD drawing.

When the shaping process is used to produce the shaped sheet of glass, it is usually desired to measure the shape of the sheet of glass that has been produced. This allows the shaping process to be monitored and/or to determine if there are shaped sheets of glass outside a predetermined shape tolerance so that such mis-shaped sheet of glass can be rejected. Measuring the shape produced allows the shaping process to be adjusted to ensure more shaped sheets of glass fall inside the predetermined shape tolerance, thereby reducing waste.

In order to measure the shape of the shaped sheet of glass, a support for the shaped or curved sheet of glass is required. Typically, a support is made for each design of shaped sheet of glass. Such a support usually uses a CNC machined fixture containing multiple support points (often about ten). The shaped sheet of glass is positioned on the CNC machined fixture and is supported by the support points and Linear Variable Differential Transformer (LVDT) contact probes are used to measure shape differences. Such an approach is problematic because a new fixture to support the shaped sheet of glass is required each time a different design of shaped sheet of glass is to be measured. This is expensive and time consuming.

Also, contact with the shaped sheet of glass at many points increases the possibility of damage to the shaped sheet of glass and may deform the shape of the sheet of glass as the sheet of glass comes to rest on the contact point. Reducing the number of contact points to support the shaped sheet of glass may cause the shaped sheet of glass to distort because the contact points are not in the optimum position to support the particular shaped sheet of glass.

The present invention aims to at least partially overcome the above problems.

Accordingly, from a first aspect the present invention provides a support for a sheet of glass, the support comprising a first support assembly and a second support assembly; wherein the first support assembly comprises a first base and a first arm assembly, the first arm assembly comprising a first arm having a first end and a second end opposite the first end thereof, there being at least a first contact surface at each of the first and second ends of the first arm for contacting a first major surface of the sheet of glass when the sheet of glass is supported on the support; the first arm assembly being coupled to the first base by a first coupling for rotation about a first pivot axis, the first coupling being between the first and second ends of the first arm; further wherein the second support assembly comprises a second base and a second arm assembly, the second arm assembly comprising a second arm having a first end and a second end opposite the first end thereof, there being at least a first contact surface at each of the first and second ends of the second arm for contacting the first major surface of the sheet of glass when the sheet of glass is supported on the support; the second arm assembly being coupled to the second base by a second coupling for rotation about a second pivot axis; the second coupling being between the first and second ends of the second arm.

When a sheet of glass is supported on the support, at least the first contact surfaces of the first and second arm assemblies are arranged to contact the first major surface of the sheet of glass thereby supporting the sheet of glass on the support.

For the avoidance of doubt, the sheet of glass to be supported has a first major surface and an opposing second major surface. Also, the sheet of glass may be shaped or bent in at least one direction such that the sheet of glass is curved in at least one direction. Preferably the radius of curvature in the at least one direction is between 500 mm and 20000 mm, more preferably between 1000 mm and 8000 mm. When a sheet of glass is shaped or bent in at least one direction, such a sheet of glass may also be referred to as a curved sheet of glass, or a bent sheet of glass, or a shaped sheet of glass. The sheet of glass may have a major surface area between 0.5 m² and 10 m².

Preferably the first arm is an elongate member having a longitudinal axis, preferably wherein the first and second ends of the first arm lie at opposite end of the longitudinal axis of the first arm.

Preferably the second arm is an elongate member having a longitudinal axis, preferably wherein the first and second ends of the second arm lie at opposite end of the longitudinal axis of the second arm.

It has been found that using a support according to the present invention that has two support assemblies coupled to a base for rotation about a respective pivot axis, the support is able to better accommodate different glass shapes, for example that may arise due to manufacturing tolerances when making a specific glass shape or when making a different shaped sheet of glass, because of the rotational degrees of freedom of the support assemblies. Furthermore, the rotational degrees of freedom allow the support to rapidly reach an equilibrium configuration by balancing forces at each contact surface thereby reducing vibration of the sheet of glass on the support. This provides an additional advantage in that the support may be used to support a sheet of glass for measuring the shape thereof using a non-contact distance sensor such as a confocal displacement sensor. Such sensors may be susceptible to vibration of the part being measured. By having a support that rapidly reaches a stable configuration by dampening vibrations allow non-contact distance sensors to be used thereby allowing rapid measurement of the shape of the sheet of glass. It is preferred that the first support assembly is arranged relative to the second support assembly such that the first pivot axis is parallel to the second pivot axis.

In some embodiments the first arm comprises a first portion extending away from the first end of the first arm and the first contact surface at the first end of the first arm is at an end of the first portion at the first end of the first arm.

Preferably the first portion at the first end of the first arm is fixed relative to the first arm. In such embodiments is it preferred that the first portion at the first end of the first arm is integrally formed with the first arm.

Preferably the first contact surface at the end of the first portion at the first end of the first arm is configured to provide point contact with the first major surface of the sheet of glass when the sheet of glass is supported on the support.

Preferably the first contact surface at the end of the first portion at the first end of the first arm is at least partially aligned with a longitudinal axis of the first arm.

Preferably the first contact surface at the end of the first portion at the first end of the first arm is provided by a wheel suitably coupled to the end of the first portion at the first end of the first arm. Preferably the wheel at the end of the first portion at the first end of the first arm has an axis of rotation parallel to the first pivot axis.

Preferably the first contact surface at the end of the first portion at the first end of the first arm is part of a ball castor (often spelt caster). In the art, a ball castor is often known as a ball transfer unit and generally comprises a spherical ball inside a restraining fixture. Preferably the first contact surface at the end of the first portion at the first end of the first arm is part of the surface of the ball of the ball castor. In these embodiments the first contact surface at the end of the first portion at the end of the first arm is movable relative to the first arm.

In some embodiments the first arm comprises at the first end thereof a third arm being fixed relative to first arm, the third arm having a first end and a second end, wherein the first contact surface at the first end of the first arm is at the first end of the third arm, there being a second contact surface at the second end of the third arm, the first contact surface at the first end of the third arm and the second contact surface at the second end of the third arm being arranged to contact the first major surface of the sheet of glass when the sheet of glass is supported on the support.

Preferably the third arm is fixed to the first end of the first arm such that the first contact surface at the first end of the third arm is on a first side of the first arm and the second contact surface at the second end of the third arm is on an opposite side of the first arm.

Preferably the third arm is orthogonal to the first arm.

Preferably the third arm is parallel to the first pivot axis.

Preferably a fixing is between the first end of the first arm and the third arm to fix the third arm to the first end of the first arm; or the third arm is integrally formed with the first arm.

Preferably the first contact surface at the first end of the third arm is configured to provide point contact with the first major surface of the sheet of glass when the sheet of glass is supported on the support.

Preferably the second contact surface at the second end of the third arm is configured to provide point contact with the first major surface of the sheet of glass when the sheet of glass is supported on the support.

Preferably the first contact surface at the first end of the third arm is at least partially aligned with a longitudinal axis of the third arm.

Preferably the second contact surface at the second end of the third arm is at least partially aligned with a longitudinal axis of the third arm.

Preferably the first contact surface at the first end of the third arm is provided by a first wheel suitably coupled to the first end of the third arm. Preferably the first wheel at the first end of the third arm has an axis of rotation parallel to the first pivot axis.

Preferably the second contact surface at the second end of the third arm is provided by a second wheel suitably coupled to the second end of the third arm. Preferably the second wheel at the second end of the third arm has an axis of rotation parallel to the first pivot axis.

Preferably the first contact surface at the first end of the third arm is part of a surface of a ball of a first ball castor.

Preferably the second contact surface at the second end of the third arm is part of a surface of a ball of a second ball castor.

In some embodiments the first arm comprises a first portion extending away from the first end of the first arm, the first contact surface at the first end of the first arm is at an end of the first portion at the first end of the first arm, and the first portion at the first end of the first arm is coupled to first end of the first arm for rotation about a third pivot axis.

Preferably the first portion at the first end of the first arm comprises a third arm having a first end and a second end, the third arm being coupled to the first end of the first arm by a coupling that is between the first and second ends of the third arm.

Preferably the first and second ends of the third arm are at opposite ends of the third arm, more preferably at opposite ends of a longitudinal axis of the third arm

Preferably the coupling that couples the third arm to the first end of the first arm is aligned with a longitudinal axis of the third arm.

Preferably the coupling that couples the third arm to the first end of the first arm is vertically aligned with a centre of mass of the third arm.

Preferably the coupling that couples the third arm to the first end of the first arm comprises a pivot hinge and/or a bearing.

Preferably the first contact surface at the first end of the first arm is at the first end of the third arm and a second contact surface is at the second end of the third arm arranged such that when the sheet of glass is supported on the support, the first major surface of the sheet of glass contacts the first contact surface at the first end of the third arm and the second contact surface at the second end of the third arm.

Preferably at least one of the first contact surface at the first end of the third arm and the second contact surface at the second end of the third arm is aligned with a longitudinal axis of the third arm.

Preferably at least one of the first contact surface at the first end of the third arm and the second contact surface at the second end of the third arm is configured to provide point contact with the first major surface of the sheet of glass when the sheet of glass is supported on the support.

Preferably the first contact surface at the first end of the third arm is part of a surface of a ball of a first ball castor.

Preferably the second contact surface at the second end of the third arm is part of a surface of a ball of a second ball castor.

Preferably the third pivot axis is orthogonal to the first pivot axis.

Preferably the first support assembly is arranged relative to the second support assembly such that the third pivot axis is orthogonal to the second pivot axis.

Preferably the coupling that couples the first portion at the first end of the first arm to the first end of the first arm is locked such that rotation about the third pivot axis is prevented.

In such embodiments where the coupling is locked, the first contact surface is preferably provided by a wheel suitably coupled to the end of the first portion at the first end of the first arm. Preferably the

at the end of the first portion at the first end of the first arm has an axis of rotation parallel to the first pivot axis.

In such embodiments where the coupling is locked and the first portion at the first end of the first arm comprises a third arm with a first contact surface at a first end of the third arm and a second contact surface at a second end of the third arm, preferably the first contact surface at the first end of the third arm is provided by a first wheel suitably coupled to the first end of the third arm for rotation about a first wheel axis, preferably wherein the first wheel axis of the first wheel at the first end of the third arm is parallel to the first pivot axis; and/or wherein the second contact surface at the second end of the third arm is provided by a second wheel suitably coupled to the second end of the third arm for rotation about a second wheel axis, preferably wherein the second wheel axis of the second wheel at the second end of the third arm is parallel to the first pivot axis.

In some embodiments, the first arm comprises a second portion extending away from the second end of the first arm and the first contact surface at the second end of the first arm is at an end of the second portion at the second end of the first arm.

Preferably the second portion at the second end of the first arm is fixed relative to the first arm. In such embodiments it is preferred that the second portion at the second end of the first arm is integrally formed with the first arm.

Preferably the first contact surface at the end of the second portion at the second end of the first arm is configured to provide point contact with the first major surface of the sheet of glass when the sheet of glass is supported on the support.

Preferably the first contact surface at the end of the second portion at the second end of the first arm is at least partially aligned with a longitudinal axis of the first arm.

Preferably the first contact surface at the end of the second portion at the second end of the first arm is provided by a wheel suitably coupled to the end of the second portion at the second end of the first arm. Preferably the wheel at the end of the second portion at the second end of the first arm has an axis of rotation parallel to the first pivot axis.

Preferably the first contact surface at the end of the second portion at the second end of the first arm is part of a surface of a ball of a ball castor.

In some embodiments the first arm comprises at the second end thereof a fourth arm being fixed relative to first arm, the fourth arm having a first end and a second end, wherein the first contact surface at the second end of the first arm is at the first end of the fourth arm, there being a second contact surface at the second end of the fourth arm, the first contact surface at the first end of the fourth arm and the second contact surface at the second end of the fourth arm being arranged to contact the first major surface of the sheet of glass when the sheet of glass is supported on the support.

Preferably the fourth arm is fixed to the second end of the first arm such that the first contact surface at the first end of the fourth arm is on a first side of the first arm and the second contact surface at the second end of the fourth arm is on an opposite side of the first arm.

Preferably the fourth arm is orthogonal to the first arm.

Preferably the fourth arm is parallel to the first pivot axis.

Preferably a fixing is between the second end of the first arm and the fourth arm to fix the fourth arm to the second end of the first arm; or the fourth arm is integrally formed with the first arm.

Preferably the first contact surface at the first end of the fourth arm is configured to provide point contact with the first major surface of the sheet of glass when the sheet of glass is supported on the support.

Preferably the second contact surface at the second end of the fourth arm is configured to provide point contact with the first major surface of the sheet of glass when the sheet of glass is supported on the support.

Preferably the first contact surface at the first end of the fourth arm is at least partially aligned with a longitudinal axis of the fourth arm.

Preferably the second contact surface at the second end of the fourth arm is at least partially aligned with a longitudinal axis of the fourth arm.

Preferably the first contact surface at the first end of the fourth arm is provided by a first wheel suitably coupled to the first end of the fourth arm. Preferably the first wheel at the first end of the fourth arm has an axis of rotation parallel to the first pivot axis.

Preferably the second contact surface at the second end of the fourth arm is provided by a second wheel suitably coupled to the second end of the fourth arm. Preferably the second wheel at the second end of the fourth arm has an axis of rotation parallel to the first pivot axis.

Preferably the first contact surface at the first end of the fourth arm is part of a surface of a ball of a first ball castor.

Preferably the second contact surface at the second end of the fourth arm is part of a surface of a ball of a second ball castor.

In some embodiments the first arm comprises a second portion extending away from the second end of the first arm, the first contact surface at the second end of the first arm is at an end of the second portion at the second end of the first arm, and the second portion at the second end of the first arm is coupled to the second end of the first arm for rotation about a fourth pivot axis.

Preferably the second portion at the second end of the first arm comprises a fourth arm having a first end and a second end, the fourth arm being coupled to the second end of the first arm by a coupling that is between the first and second ends of the fourth arm.

Preferably the first and second ends of the fourth arm are at opposite ends of the fourth arm, more preferably at opposite ends of a longitudinal axis of the fourth arm Preferably the coupling that couples the second portion at the second end of the first arm to the second end of the first arm is aligned with a longitudinal axis of the fourth arm.

Preferably the coupling that couples the fourth arm to the second end of the first arm is vertically aligned with a centre of mass of the fourth arm.

Preferably the coupling that couples the fourth arm to the second end of the first arm comprises a pivot hinge and/or a bearing.

Preferably the first contact surface at the second end of the first arm is at the first end of the fourth arm and a second contact surface is at the second end of the fourth arm arranged such that when the sheet of glass is supported on the support, the first major surface of the sheet of glass contacts the first contact surface at the first end of the fourth arm and the second contact surface at the second end of the fourth arm.

Preferably at least one of the first contact surface at the first end of the fourth arm and the second contact surface at the second end of the fourth arm is aligned with a longitudinal axis of the fourth arm.

Preferably at least one of the first contact surface at the first end of the fourth arm and the second contact surface at the second end of the fourth arm is configured to provide point contact with the first major surface of the sheet of glass when the sheet of glass is supported on the support.

Preferably the first contact surface at the first end of the fourth arm is part of a surface of a ball of a first ball castor.

Preferably the second contact surface at the second end of the fourth arm is part of a surface of a ball of a second ball castor.

Preferably the fourth pivot axis is orthogonal to the first pivot axis.

Preferably the first support assembly is arranged relative to the second support assembly such that the fourth pivot axis is orthogonal to the second pivot axis.

Preferably the coupling that couples the second portion at the second end of the first arm to the second end of the first arm is locked such that rotation about the fourth pivot axis is prevented.

In such embodiments where the coupling is locked, the first contact is preferably provided by a wheel suitably coupled to the end of the second portion at the second end of the first arm. Preferably the wheel at the end of the second portion at the second end of the first arm has an axis of rotation parallel to the first pivot axis.

In such embodiments where the coupling is locked and the second portion at the second end of the first arm comprises a fourth arm with a first contact surface at a first end of the fourth arm and a second contact surface at a second end of the fourth arm, preferably the first contact surface at the first end of the fourth arm is provided by a first wheel suitably coupled to the first end of the fourth arm for rotation about a first wheel axis, preferably wherein the first wheel axis of the first wheel of at the first end of the fourth arm is parallel to the first pivot axis; and/or wherein the second contact surface at the second end of the fourth arm is provided by a second wheel suitably coupled to the second end of the fourth arm for rotation about a second wheel axis, preferably wherein the second wheel axis of the second wheel at the second end of the fourth arm is parallel to the first pivot axis.

In some embodiments the first arm comprises a first portion extending away from the first end of the first arm, and the first contact surface at the first end of the first arm is at an end of the first portion at the first end of the first arm; and the first arm also comprises a second portion extending away from the second end of the first arm, and the first contact surface at the second end of the first arm is at an end of the second portion at the second end of the first arm.

In some embodiments the first arm comprises a first portion extending away from the first end of the first arm, and the first contact surface at the first end of the first arm is at an end of the first portion of the first arm, the first portion at the first end of the first arm being coupled to the first end of the first arm for rotation about a third pivot axis; and wherein the first arm also comprises a second portion extending away from the second end of the first arm, and the first contact surface at the second end of the first arm is at an end of the second portion at the second end of the first arm, the second portion at the second end of the first arm being coupled to the second end of the first arm for rotation about a fourth pivot axis.

Preferably the third pivot axis is aligned with the fourth pivot axis.

Preferably the third and/or fourth pivot axis is orthogonal to the first and/or second pivot axis.

Preferably the first support assembly is arranged relative to the second support assembly such that the third and/or fourth pivot axis is orthogonal to the second pivot axis.

Preferably the coupling that couples the first portion at the first end of the first arm to first end of the first arm for rotation about the third pivot axis is locked such that rotation about the third pivot axis is prevented. That is, in use, rotation about the third pivot axis is prevented

Preferably the coupling that couples the second portion at the second end of the first arm to the second end of the first arm for rotation about the fourth pivot axis is locked such that rotation about the fourth pivot axis is prevented. That is, in use, rotation about the fourth pivot axis is prevented.

In some embodiments, the second arm comprises a first portion extending away from the first end of the second arm and the first contact surface at the first end of the second arm is at an end of the first portion at the first end of the second arm.

Preferably the first portion at the first end of the second arm is fixed relative to the second arm. In such embodiments it is preferred that the first portion at the first end of the second arm is integrally formed with the second arm.

Preferably the first contact surface at the end of the first portion at the first end of the second arm is configured to provide point contact with the first major surface of the sheet of glass when the sheet of glass is supported on the support.

Preferably the first contact surface at the end of the first portion at the first end of the first arm is at least partially aligned with a longitudinal axis of the second arm.

Preferably the first contact surface at the end of the first portion at the first end of the second arm is provided by a wheel suitably coupled to the end of the first portion at the first end of the second arm. Preferably the wheel at the end of the first portion at the first end of the second arm has an axis of rotation parallel to the first pivot axis.

Preferably the first contact surface at the end of the first portion at the first end of the second arm is part of a surface of a ball of a ball castor.

In some embodiments the second arm comprises at the first end thereof a fifth arm being fixed relative to second arm, the fifth arm having a first end and a second end, wherein the first contact surface at the first end of the second arm is at the first end of the fifth arm, there being a second contact surface at the second end of the fifth arm, the first contact surface at the first end of the fifth arm and the second contact surface at the second end of the fifth arm being arranged to contact the first major surface of the sheet of glass when the sheet of glass is supported on the support.

Preferably the fifth arm is fixed to the first end of the second arm such that the first contact surface at the first end of the fifth arm is on a first side of the second arm and the second contact surface at the second end of the fifth arm is on an opposite side of the second arm.

Preferably the fifth arm is orthogonal to the second arm.

Preferably the fifth arm is parallel to the second pivot axis.

Preferably a fixing is between the first end of the second arm and the fifth arm to fix the fifth arm to the first end of the second arm; or the fifth arm is integrally formed with the second arm.

Preferably the first contact surface at the first end of the fifth arm is configured to provide point contact with the first major surface of the sheet of glass when the sheet of glass is supported on the support.

Preferably the second contact surface at the second end of the fifth arm is configured to provide point contact with the first major surface of the sheet of glass when the sheet of glass is supported on the support.

Preferably the first contact surface at the first end of the fifth arm is at least partially aligned with a longitudinal axis of the fifth arm.

Preferably the second contact surface at the second end of the fifth arm is at least partially aligned with a longitudinal axis of the fifth arm.

Preferably the first contact surface at the first end of the fifth arm is provided by a first wheel suitably coupled to the first end of the fifth arm. Preferably the first wheel at the first end of the fifth arm has an axis of rotation parallel to the second pivot axis.

Preferably the second contact surface at the second end of the fifth arm is provided by a second wheel suitably coupled to the second end of the fifth arm. Preferably the second wheel at the second end of the fifth arm has an axis of rotation parallel to the second pivot axis.

Preferably the first contact surface at the first end of the fifth arm is part of a surface of a ball of a first ball castor.

Preferably the second contact surface at the second end of the fifth arm is part of a surface of a ball of a second ball castor.

In some embodiments, the second arm comprises a first portion extending away from the first end of the second arm, the first contact surface at the first end of the second arm is at an end of the first portion at the first end of the second arm, and the first portion at the first end of the second arm is coupled to first end of the second arm for rotation about a fifth pivot axis.

Preferably the first portion at the first end of the second arm comprises a fifth arm having a first end and a second end, the fifth arm being coupled to the first end of the second arm by a coupling that is between the first and second ends of the fifth arm.

Preferably the first and second ends of the fifth arm are at opposite ends the fifth arm, more preferably at opposite ends of a longitudinal axis of the fifth arm.

Preferably the coupling that couples the fifth arm to the first end of the second arm is aligned with a longitudinal axis of the fifth arm.

Preferably the coupling that couples the fifth arm to the first end of the second arm is vertically aligned with a centre of mass of the fifth arm.

Preferably the coupling that couples the fifth arm to the first end of the second arm comprises a pivot hinge and/or a bearing.

Preferably the first contact surface at the first end of the second arm is at the first end of the fifth arm and a second contact surface is at the second end of the fifth arm arranged such that when the sheet of glass is supported on the support, the first major surface of the sheet of glass contacts the first contact surface at the first end of the fifth arm and the second contact surface at the second end of the fifth arm.

Preferably at least one of the first contact surface at the first end of the fifth arm and the second contact surface at the second end of the fifth arm is aligned with a longitudinal axis of the fifth arm.

Preferably at least one of the first contact surface at the first end of the fifth arm and the second contact surface at the second end of the fifth arm is configured to provide point contact with the first major surface of the sheet of glass when the sheet of glass is supported on the support.

Preferably the first contact surface at the first end of the fifth arm is part of a surface of a ball of a first ball castor.

Preferably the second contact surface at the second end of the fifth arm is part of a surface of a ball of a second ball castor.

Preferably the fifth pivot axis is orthogonal to the second pivot axis.

Preferably the first support assembly is arranged relative to the second support assembly such that the fifth pivot axis is orthogonal to the first pivot axis.

Preferably the coupling that couples the first portion at the first end of the second arm to the first end of the second arm is locked such that rotation about the fifth pivot axis is prevented. That is, in use, rotation about the fifth pivot axis is prevented.

In such embodiments where the coupling is locked, the first contact surface is preferably provided by a wheel suitably coupled to the end of the first portion at the first end of the second arm. Preferably the wheel at the end of the first portion at the first end of the second arm has an axis of rotation parallel to the second pivot axis.

In such embodiments where the coupling is locked and the first portion at the first end of the second arm comprises a fifth arm with a first contact surface at a first end of the fifth arm and a second contact surface at a second end of the fifth arm, preferably the first contact surface at the first end of the fifth arm is provided by a first wheel suitably coupled to the first end of the fifth arm for rotation about a first wheel axis, preferably wherein the first wheel axis of the first wheel at the first end of the fifth arm is parallel to the second pivot axis; and/or wherein the second contact surface at the second end of the fifth arm is provided by a second wheel suitably coupled to the second end of the fifth arm for rotation about a second wheel axis, preferably wherein the second wheel axis of the second wheel at the second end of the fifth arm is parallel to the second pivot axis.

In some embodiments the second arm comprises a second portion extending away from the second end of the second arm, and wherein the first contact surface at the second end of the second arm is at an end of the second portion at the second end of the second arm.

Preferably the second portion at the second end of the second arm is fixed relative to the second arm. In such embodiments it is preferred that the second portion at the second end of the second arm is integrally formed with the second arm.

Preferably the first contact surface at the end of the second portion at the second end of the second arm is configured to provide point contact with the first major surface of the sheet of glass when the sheet of glass is supported on the support.

Preferably the first contact surface at the end of the second portion at the second end of the second arm is at least partially aligned with a longitudinal axis of the second arm.

Preferably the first contact surface at the end of the second portion at the second end of the second arm is provided by a wheel suitably coupled to the end of the second portion at the second end of the second arm. Preferably the wheel at the end of the second portion at the second end of the second arm has an axis of rotation parallel to the second pivot axis.

Preferably the first contact surface at the end of the second portion at the second end of the second arm is part of a surface of a ball of a ball castor.

In some embodiments the second arm comprises at the second end thereof a sixth arm being fixed relative to second arm, the sixth arm having a first end and a second end, wherein the first contact surface at the second end of the second arm is at the first end of the sixth arm, there being a second contact surface at the second end of the sixth arm, the first contact surface at the first end of the sixth arm and the second contact surface at the second end of the sixth arm being arranged to contact the first major surface of the sheet of glass when the sheet of glass is supported on the support.

Preferably the sixth arm is fixed to the second end of the second arm such that the first contact surface at the first end of the sixth arm is on a first side of the second arm and the second contact surface at the second end of the sixth arm is on an opposite side of the second arm.

Preferably the sixth arm is orthogonal to the second arm.

Preferably the sixth arm is parallel to the second pivot axis.

Preferably a fixing is between the second end of the second arm and the sixth arm to fix the sixth arm to the second end of the second arm; or the sixth arm is integrally formed with the second arm.

Preferably the first contact surface at the first end of the sixth arm is configured to provide point contact with the first major surface of the sheet of glass when the sheet of glass is supported on the support.

Preferably the second contact surface at the second end of the sixth arm is configured to provide point contact with the first major surface of the sheet of glass when the sheet of glass is supported on the support.

Preferably the first contact surface at the first end of the sixth arm is at least partially aligned with a longitudinal axis of the sixth arm.

Preferably the second contact surface at the second end of the sixth arm is at least partially aligned with a longitudinal axis of the sixth arm.

Preferably the first contact surface at the first end of the sixth arm is provided by a first wheel suitably coupled to the first end of the sixth arm. Preferably the first wheel at the first end of the sixth arm has an axis of rotation parallel to the second pivot axis.

Preferably the second contact surface at the second end of the sixth arm is provided by a second wheel suitably coupled to the second end of the sixth arm. Preferably the second wheel at the second end of the sixth arm has an axis of rotation parallel to the second pivot axis.

Preferably the first contact surface at the first end of the sixth arm is part of a surface of a ball of a first ball castor.

Preferably the second contact surface at the second end of the sixth arm is part of a surface of a ball of a second ball castor.

In some embodiments the second arm comprises a second portion extending away from the second end of the second arm, the first contact surface at the second end of the second arm is at an end of the second portion at the second end of the second arm, and the second portion at the second end of the second arm is coupled to the second end of the second arm for rotation about a sixth pivot axis.

Preferably the second portion at the second end of the second arm comprises a sixth arm having a first end and a second end, the sixth arm being coupled to the second end of the second arm by a coupling that is between the first and second ends of the sixth arm.

Preferably the first and second ends of the sixth arm are at opposite ends of the sixth arm, more preferably at opposite ends of a longitudinal axis of the sixth arm.

Preferably the coupling that couples the second portion at the second end of the second arm to the second end of the second arm is aligned with a longitudinal axis of the sixth arm.

Preferably the coupling that couples the sixth arm to the second end of the second arm is vertically aligned with a centre of mass of the sixth arm.

Preferably the coupling that couples the sixth arm to the second end of the second arm comprises a pivot hinge and/or a bearing.

Preferably the first contact surface at the second end of the second arm is at the first end of the sixth arm and a second contact surface is at the second end of the sixth arm arranged such that when the sheet of glass is supported on the support, the first major surface of the sheet of glass contacts the first contact surface at the first end of the sixth arm and the second contact surface at the second end of the sixth arm.

Preferably at least one of the first contact surface at the first end of the sixth arm and the second contact surface at the second end of the sixth arm is aligned with a longitudinal axis of the sixth arm.

Preferably at least one of the first contact surface at the first end of the sixth arm and the second contact surface at the second end of the sixth arm is configured to provide point contact with the first major surface of the sheet of glass when the sheet of glass is supported on the support.

Preferably the first contact surface at the first end of the sixth arm is part of a surface of a ball of a first ball castor.

Preferably the second contact surface at the second end of the sixth arm is part of a surface of a ball of a second ball castor.

Preferably the sixth pivot axis is orthogonal to the second pivot axis.

Preferably the first support assembly is arranged relative to the second support assembly such that the sixth pivot axis is orthogonal to the first pivot axis.

Preferably the coupling that couples the second portion at the second end of the second arm to the second end of the second arm is locked such that rotation about the sixth pivot axis is prevented. That is, in use, rotation about the sixth pivot axis is prevented.

In such embodiments where the coupling is locked, the first contact is preferably provided by a wheel suitably coupled to the end of the second portion at the second end of the second arm. Preferably the wheel at the end of the second portion at the second end of the second arm has an axis of rotation parallel to the second pivot axis.

In such embodiments where the coupling is locked and the second portion at the second end of the second arm comprises a sixth arm with a first contact surface at a first end of the sixth arm and a second contact surface at a second end of the sixth arm, preferably the first contact surface at the first end of the sixth arm is provided by a first wheel suitably coupled to the first end of the sixth arm for rotation about a first wheel axis, preferably wherein the first wheel axis of the first wheel of at the first end of the sixth arm is parallel to the second pivot axis; and/or wherein the second contact surface at the second end of the sixth arm is provided by a second wheel suitably coupled to the second end of the sixth arm for rotation about a second wheel axis, preferably wherein the second wheel axis of the second wheel at the second end of the sixth arm is parallel to the second pivot axis.

In some embodiments the second arm comprises a first portion extending away from the first end of the second arm, and the first contact surface at the first end of the second arm is at an end of the first portion at the first end of the second arm; and the second arm comprises a second portion extending away from the second end of the second arm, and the first contact surface at the second end of the second arm is at an end of the second portion at the second end of the second arm.

In some embodiments the second arm comprises a first portion extending away from the first end of the second arm, and the first contact surface at the first end of the second arm is at an end of the first portion of the first arm, the first portion at the first end of the second arm being coupled to the first end of the second arm for rotation about a fifth pivot axis; and the second arm comprises a second portion extending away from the second end of the second arm, and the first contact surface at the second end of the second arm is at an end of the second portion at the second end of the second arm, the second portion at the second end of the second arm being coupled to the second end of the second arm for rotation about a sixth pivot axis.

Preferably the fifth pivot axis is aligned with the sixth pivot axis.

Preferably the fifth and/or sixth pivot axis is orthogonal to the first and/or second pivot axis.

Preferably the first support assembly is arranged relative to the second support assembly such that the fifth and/or sixth pivot axis is orthogonal to the first pivot axis.

Preferably the coupling that couples the first portion at the first end of the second arm to first end of the second arm for rotation about the fifth pivot axis is locked such that rotation about the fifth pivot axis is prevented.

Preferably the coupling that couples the second portion at the second end of the second arm to the second end of the second arm for rotation about the sixth pivot axis is locked such that rotation about the sixth pivot axis is prevented.

In some embodiments the first arm comprises a first portion extending away from the first end of the first arm, and the first contact surface at the first end of the first arm is at an end of the first portion at the first end of the first arm, the first portion at the end of the first arm being coupled to first end of the first arm for rotation about a third pivot axis; and the first arm comprises a second portion extending away from the second end of the first arm, and the first contact surface at the second end of the first arm is at an end of the second portion at the second end of the first arm, the second portion at the second end of the first arm being coupled to the second end of the first arm for rotation about a fourth pivot axis; and the second arm comprises a first portion extending away from the first end of the second arm, and the first contact surface at the first end of the second arm is at an end of the first portion at the first end of the second arm, the first portion at the first end of the second arm being coupled to the first end of the second arm for rotation about a fifth pivot axis; and the second arm comprises a second portion extending away from the second end of the second arm, and the first contact surface at the second end of the second arm is at an end of the second portion at the second end of the second arm, the second portion at the second end of the second arm being coupled to the second end of the second arm for rotation about a sixth pivot axis.

In some embodiments the first arm comprises a first portion extending away from the first end of the first arm, and the first contact surface at the first end of the first arm is at an end of the first portion at the end of the first arm, the first portion at the first end of the first arm being coupled to first end of the first arm for rotation about a third pivot axis; and the first arm comprises a second portion extending away from the second end of the first arm, and the first contact surface at the second end of the first arm is at an end of the second portion at the second end of the first arm, the second portion at the second end of the first arm being fixed relative to the first arm; and the second arm comprises a first portion extending away from the first end of the second arm, and the first contact surface at the first end of the second arm is at an end of the first portion at the first end of the second arm, the first portion at the first end of the second arm being coupled to first end of the second arm for rotation about another pivot axis; and the second arm comprises a second portion extending away from the second end of the second arm, and the first contact surface at the second end of the second arm being at an end of the second portion at the second end of the second arm, the second portion at the second end of the second arm being fixed relative to the second arm.

Preferably the third pivot axis is aligned with the other pivot axis.

Preferably the third and/or the other pivot axis is orthogonal to the first and/or second pivot axis.

In some embodiments the support comprises at least a first damper is associated with the first and/or second support assembly.

In some embodiments the first support assembly comprises at least a first damper to reduce the time taken for the first arm assembly to establish an equilibrium configuration.

Preferably the damper reduces an amplitude of vibrations that may occur when the sheet of glass is initially placed on the support, or from a subsequent impulse causing the sheet of glass to move on the support.

Preferably the first damper comprise a spring and/or a dashpot.

Preferably the first damper comprises a mass damper, in particular a Stockbridge damper.

Preferably the first damper comprises a mass damper attached at the first and/or second ends of the first arm.

Preferably the first damper comprises at least one of mass damper comprising a flexible arm, in particular a stranded steel cable, with a mass at each of the flexible arm, the flexible arm being attached to an end of the first arm.

Preferably the damper comprises a rotary damper.

In some embodiments the second support assembly comprises at a first damper to reduce the time taken for the second arm assembly to establish an equilibrium configuration.

Preferably the first damper reduces an amplitude of vibrations that may occur when the sheet of glass is initially placed on the support, or from a subsequent impulse causing the sheet of glass to move on the support.

Preferably the first damper comprise a spring and/or a dashpot.

Preferably the first damper comprises a mass damper, in particular a Stockbridge damper.

Preferably the first damper comprises a mass damper attached at the first and/or second ends of the second arm.

Preferably the first damper comprises at least one of mass damper comprising a flexible arm, in particular a stranded steel cable, with a mass at each of the flexible arm, the flexible arm being attached to an end of the second arm.

Preferably the first damper comprises a rotary damper.

In some embodiments, at least the first contact surface at the first end of the first arm is movable relative to the first arm.

Preferably the first contact surface at the first end of the first arm is part of a wheel or a castor.

Preferably the first contact surface at the first end of the first arm is part of a ball castor, more preferably a part of a surface of the ball of the ball castor.

In some embodiments, at least the first contact surface at the second end of the first arm is movable relative to the first arm.

Preferably the first contact surface at the second end of the first arm is part of a wheel or a castor.

Preferably the first contact surface at the second end of the first arm is part of a ball castor, more preferably a part of a surface of the ball of the ball castor.

In some embodiments, at least the first contact surface at the first end of the second arm is movable relative to the second arm.

Preferably the first contact surface at the first end of the second arm is part of a wheel or a castor.

Preferably the first contact surface at the first end of the second arm is part of a ball castor, more preferably a part of a surface of the ball of the ball castor.

In some embodiments, at least the first contact surface at the second end of the second arm is movable relative to the second arm.

Preferably the first contact surface at the second end of the second arm is part of a wheel or a castor.

Preferably the first contact surface at the second end of the second arm is part of a ball castor, more preferably a part of a surface of the ball of the ball castor.

In some embodiments, at least the first contact surface at the first end of the first arm is part of a first contact assembly at the first end of the first arm, the first contact assembly at the first end of the first arm comprising a compressible damper configured such that when the first arm is static relative to the first base, the first contact surface at the first end of the first arm is movable towards the first base upon compressing the damper that is part of the first contact assembly at the first end of the first arm.

Preferably the damper that is part of the first contact assembly at the first end of the first arm comprises a spring or resilient member.

In some embodiments, at least the first contact surface at the second end of the first arm is part of a second contact assembly at the second end of the first arm, the second contact assembly at the second end of the first arm comprising a compressible damper configured such that when the first arm is static relative to the first base, the first contact surface at the second end of the first arm is movable towards the first base upon compressing the damper that is part of the second contact assembly at the second end of the first arm.

Preferably the damper that is part of the second contact assembly at the second end of the first arm comprises a spring or resilient member.

In some embodiments, at least the first contact surface at the first end of the second arm is part of a third contact assembly at the first end of the second arm, the third contact assembly at the first end of the second arm comprising a compressible damper configured such that when the second arm is static relative to the second base, the first contact surface at the first end of the second arm is movable towards the second base upon compressing the damper that is part of the third contact assembly at the first end of the second arm.

Preferably the damper that is part of the third contact assembly at the first end of the second arm comprises a spring or resilient member.

In some embodiments, at least the first contact surface at the second end of the second arm is part of a fourth contact assembly at the second end of the second arm, the fourth contact assembly at the second end of the second arm comprising a compressible damper configured such that when the second arm is static relative to the second base, the first contact surface at the second end of the second arm is movable towards the second base upon compressing the damper that is part of the fourth contact assembly at the second end of the second arm.

Preferably the damper that is part of the fourth contact assembly at the second end of the second arm comprises a spring or resilient member.

In some embodiments the first support assembly comprises at least a first stop so that when a sheet of glass is supported on the support, the sheet of glass is positioned on the support relative to the first stop of the first support assembly.

Preferably the first support assembly further comprises a second stop arranged such that when a sheet of glass is supported on the support, the first stop of the first support assembly is opposite a first edge portion of the sheet of glass and the second stop of the first support assembly is opposite a second edge portion of the sheet of glass.

Preferably the first edge portion of the sheet of glass is along an opposite edge of the sheet of glass to the second edge portion of the sheet of glass.

Embodiments wherein the first support assembly comprises at least a first stop are particularly useful when the first contact surface at the first and/or second end of the first arm is movable relative to the first arm. By providing the first support assembly with at least a first stop, the position of the sheet of glass relative to the first support assembly when supported on the support is stopped by the first stop of the first support assembly. Configuring the first support assembly with more than one stop, especially around the perimeter of the sheet of glass to be supported, further stops the position of the sheet of glass relative to the first support assembly when supported on the support.

In some embodiments the second support assembly comprises at least a first stop so that when a sheet of glass is supported on the support, the sheet of glass is positioned on the support relative to the first stop of the second support assembly.

Preferably the second support assembly further comprises a second stop arranged such that when a sheet of glass is supported on the support, the first stop of the second support assembly is opposite a first edge portion of the sheet of glass and the second stop of the second support assembly is opposite a second edge portion of the sheet of glass.

Preferably the first edge portion of the sheet of glass is along an opposite edge of the sheet of glass to the second edge portion of the sheet of glass.

Embodiments wherein the second support assembly comprises at least a first stop are particularly useful when the first contact surface at the first and/or second end of the second arm is movable relative to the second arm. By providing the second support assembly with at least a first stop, the position of the sheet of glass relative to the second support assembly when supported on the support is stopped by the first stop of the second support assembly. Configuring the second support assembly with more than one stop, especially around the perimeter of the sheet of glass to be supported, further stops the position of the sheet of glass relative to the second support assembly when supported on the support.

In some embodiments the first support assembly is coupled to the second support assembly such that upon moving the first arm assembly from a first configuration to a second configuration, the second arm assembly is caused to move from a first configuration to a second configuration.

Preferably the first support assembly is coupled to the second support assembly by at least one linkage in mechanical communication with the first and second arms.

Preferably the first and second configuration of the first arm assembly relate to the configuration of the first arm assembly relative to the first base and the first and second configuration of the second arm assembly relate to the configuration of the second arm assembly relative to the second base.

Preferably when the first arm assembly is in the first configuration the first arm is at a first position relative to the first base and when the first arm assembly is in the second configuration the first arm is at a second position relative to the first base.

Preferably when the second arm assembly is in the first configuration the second arm is at a first position relative to the second base and when the second arm assembly is in the second configuration the second arm is at a second position relative to the second base.

In embodiments where a contact surface is provided by a wheel, the wheel may be a spherical wheel.

In embodiments where a portion is coupled to an end of an arm for rotation about a pivot axis, and wherein the coupling that couples the portion to the end of the arm is locked such that rotation about the pivot axis is prevented, it is preferred that the coupling be a rigid coupling such that the pivot axis is an axis, and the portion is not able to rotate due to the rigid coupling (so there is no pivot axis). This however is less preferred because it is advantageous to have a coupling that is lockable so that the support is more versatile, being able to be used in different configurations compared to having a rigid coupling between the portion and the end of the arm. By way of examples, this statement applies (i) when the first portion at the first end of the first arm is coupled to the first end of the first arm for rotation about a third pivot axis, and wherein the coupling that couples the first portion at the first end of the first arm to first end of the first arm for rotation about the third pivot axis is locked such that rotation about the third pivot axis is prevented, the coupling that couples the first portion at the first end of the first arm to first end of the first arm may be replaced by a rigid coupling and (ii) when the second portion at the second end of the first arm is coupled to the second end of the first arm for rotation about a fourth pivot axis, and wherein the coupling that couples the second portion at the second end of the first arm to second end of the first arm for rotation about the fourth pivot axis is locked such that rotation about the fourth pivot axis is prevented; the coupling that couples the second portion at the second end of the first arm to second end of the first arm may be replaced by a rigid coupling.

In some embodiments the first arm assembly comprises an adjustment assembly for adjusting an equilibrium position of the first arm relative to the first base. The equilibrium position of the first arm may be determined by allowing the first arm to come to rest with no glass sheet supported on the first support assembly.

Preferably the adjustment assembly of the first arm assembly comprises at least a first mass attachable to the first arm.

Preferably the adjustment assembly of the first arm assembly comprises a first mass movably attached to the first arm such that upon moving the first mass from a first position relative to the first coupling to a second position relative to the first coupling, the first arm rotates about the first pivot axis.

Preferably the first mass is slidably attached to the first arm.

In some embodiments the second arm assembly comprises an adjustment assembly for adjusting an equilibrium position of the second arm relative to the second base. The equilibrium position of the second arm may be determined by allowing the second arm to come to rest with no glass sheet supported on the second support assembly.

Preferably the adjustment assembly of the second arm assembly comprises at least a first mass attachable to the second arm.

Preferably the adjustment assembly of the second arm assembly comprises a first mass movably attached to the second arm such that upon moving the first mass from a first position relative to the second coupling to a second position relative to the second coupling, the second arm rotates about the second pivot axis.

Preferably the first mass is slidably attached to the second arm.

In some embodiments the first arm assembly comprises an adjustment assembly for adjusting an equilibrium position of the first arm relative to the first base and the second arm assembly comprises an adjustment assembly for adjusting an equilibrium position of the second arm relative to the second base.

The equilibrium position of the first and second arm may be determined by allowing the respective arm to come to rest with no glass sheet supported on the first and second support assemblies.

Preferably the adjustment assembly of the first arm assembly comprises at least a first mass attachable to the first arm and the adjustment assembly of the second arm assembly comprises at least a second mass attachable to the second arm.

Preferably the adjustment assembly of the first arm assembly comprises a first mass movably attached to the first arm such that upon moving the first mass from a first position relative to the first coupling to a second position relative to the first coupling, the first arm rotates about the first pivot axis.

Preferably the adjustment assembly of the second arm assembly comprises a first mass movably attached to the second arm such that upon moving the first mass from a first position relative to the second coupling to a second position relative to the second coupling, the second arm rotates about the second pivot axis.

Preferably the adjustment assembly of the first arm assembly comprises a first mass movably attached to the first arm such that upon moving the first mass from a first position relative to the first coupling to a second position relative to the first coupling, the first arm rotates about the first pivot axis and the adjustment assembly of the second arm assembly comprises a second mass movably attached to the second arm such that upon moving the second mass from a first position relative to the second coupling to a second position relative to the second coupling, the second arm rotates about the second pivot axis.

Preferably the mass associated with a respective arm is slidably attached thereto.

Other embodiments of the first aspect of the present invention have other preferable features.

It is preferred that a support in accordance with the present invention does not utilise vacuum cups or suction cups. In particular, the contact surfaces that contact the first major surface of the sheet of glass when the sheet of glass is supported on the support are not provided with suction means.

It is preferred that a support in accordance with the present invention is not suitable for use at high temperatures, such as between 400° C. and 600° C.

Preferably the first arm of the first and/or second arm assembly is made of aluminium.

Preferably the first base of the first and/or second arm assembly is made of aluminium.

Preferably the first contact surface at the first and/or second end of the first arm is provided (i) by a wheel, preferably a plastic wheel, suitably coupled for rotation to the respective end of the first arm or (ii) by a ball castor, preferably comprising a plastic ball inside a restraining fixture.

Preferably the first contact surface at the first and/or second end of the second arm is provided by (i) a wheel, preferably a plastic wheel, suitably coupled for rotation to the respective end of the second arm or (ii) by a ball castor, preferably comprising a plastic ball inside a restraining fixture.

Preferably the first contact surface at the first end of the first arm is at a fixed position relative to the first arm.

Preferably the first contact surface at the first end of the second arm is at a fixed position relative to the second arm.

Preferably the first contact surface at the second end of the first arm is at a fixed position relative to the first arm.

Preferably the first contact surface at the second end of the second arm is at a fixed position relative to the second arm.

Preferably the first coupling is vertically aligned with a centre of mass of the first arm.

Preferably the second coupling is vertically aligned with a centre of mass of the second arm.

Preferably the first and/or second coupling comprises a pivot hinge and/or a bearing.

Preferably the first contact surface of at least one of the first and second ends of the first and/or second arm makes point contact with the first major surface of the sheet of glass when the sheet of glass is supported on the support.

Preferably in use, the first support assembly and the second support assembly are spaced apart from one another.

Preferably the first base and the second base are in mechanical communication, more preferably the first base is slidably connected with the second base.

Preferably the first base and the second base are integrally formed.

Preferably the sheet of glass to be supported has a line of symmetry, and wherein when the sheet of glass is supported on the support, the line of symmetry of the sheet of glass is aligned with an axis between the first pivot axis and the second pivot axis, preferably wherein the line of symmetry of the sheet of glass is aligned with an axis mid-way between the first pivot axis and the second pivot axis. The line of symmetry may be about a centreline of the sheet of glass.

Preferably the first support assembly comprises a whippletree arrangement, more preferably the first support comprises at least three arms in a whippletree arrangement.

Preferably the second support assembly comprises a whippletree arrangement, more preferably the first support comprises at least three arms in a whippletree arrangement.

Preferably the support is arranged as a whippletree, more preferably the support is arranged as a whippletree arrangement comprising at least six arms.

Preferably the support is used to support a sheet of glass during a measurement method, the measurement method being used to measure the shape of the glass sheet supported on the support.

In some embodiments, in use, the first pivot axis is aligned, or substantially aligned, with the second pivot axis.

In some embodiments, in use, the first pivot axis is parallel to the second pivot axis.

In some embodiments, in use, the first arm pivot axis is aligned, or substantially aligned, with the second arm.

In some embodiments, in use, the first arm is parallel to the second arm.

The present invention also provides from a second aspect a method of supporting a sheet of glass comprising the steps: (i) providing a glass support according to the first aspect of the present invention; and (ii) positioning the sheet of glass on the first contact surfaces of the first and second support assemblies.

Preferably the sheet of glass to be supported has a line of symmetry and wherein at step (ii) the line of symmetry of the sheet of glass is aligned with an axis between the first pivot axis and the second pivot axis, preferably an axis mid-way between the first pivot axis and the second pivot axis.

Preferably the first pivot axis is parallel to the second pivot axis.

Preferably the sheet of glass is a shaped sheet of glass.

In some embodiments, the first pivot axis is aligned, or substantially aligned, with the second pivot axis.

Preferably the sheet of glass to be supported has a line of symmetry and wherein at step (ii) the line of symmetry of the sheet of glass is parallel with the first pivot axis and/or the second pivot axis.

The present invention also provides from a third aspect a method of determining the shape of a shaped sheet of glass comprising the steps: (a) supporting the shaped sheet of glass according to the second aspect of the present invention; (b) using a shape measurement apparatus to obtain data related to the shape of the shaped sheet of glass supported on the support; and (c) using data obtained from step (b) to determine the shape of the shaped sheet of glass.

Preferably the shape measurement apparatus using during step (b) comprises a fringe projection system.

Preferably the shape measurement apparatus used during step (b) comprises a contact measurement probe, more preferably the shape measurement apparatus comprises a co-ordinate measurement machine.

Preferably the method includes the step of comparing the measured shape of the shaped sheet of glass with a reference shape, the reference shape preferably being associated with a shaped sheet of glass having a desired shape and/or a CAD representation of a shaped sheet of glass.

In some embodiments, the shape measurement apparatus used during step (b) comprises a sensor movable relative to the shaped sheet of glass to measure the distance of the shaped sheet of glass from the sensor.

Preferably the sensor is moved relative to the shaped sheet of glass to measure the distance of the shaped sheet of glass from the sensor.

Preferably the sensor is a non-contact distance measuring sensor.

Preferably the sensor comprises a confocal displacement sensor.

Preferably during step (b), the sensor is moved by a robot.

For the avoidance of doubt, the present invention also provides from an aspect a method of determining the shape of a shaped sheet of glass comprising the steps: (a) supporting the shaped sheet of glass according to the second aspect of the present invention; (b) moving a sensor relative to the shaped sheet of glass to measure the distance of the shaped sheet of glass from the sensor; and (c) using the measurements from step (b) to determine the shape of the shaped sheet of glass.

Preferably the sensor is a non-contact distance measuring sensor.

Preferably the sensor comprises a confocal displacement sensor.

Preferably at step (b), the sensor is moved by a robot.

The invention will now be described with reference to the following figures (not to scale) in which,

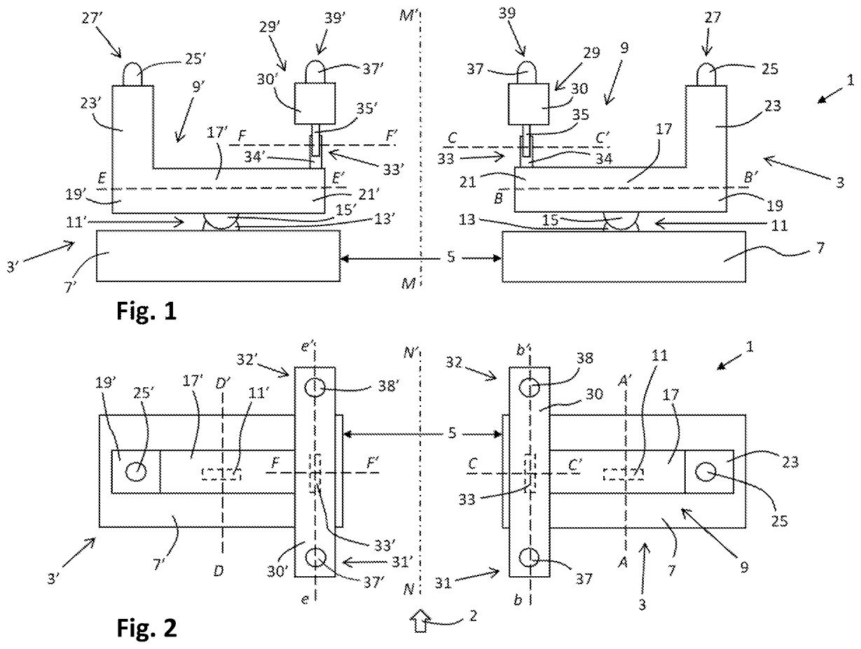

FIG. 1 shows a schematic side view representation of a support according to the first aspect of the present invention;

FIG. 2 shows a schematic plan view representation of the support shown in FIG. 1;

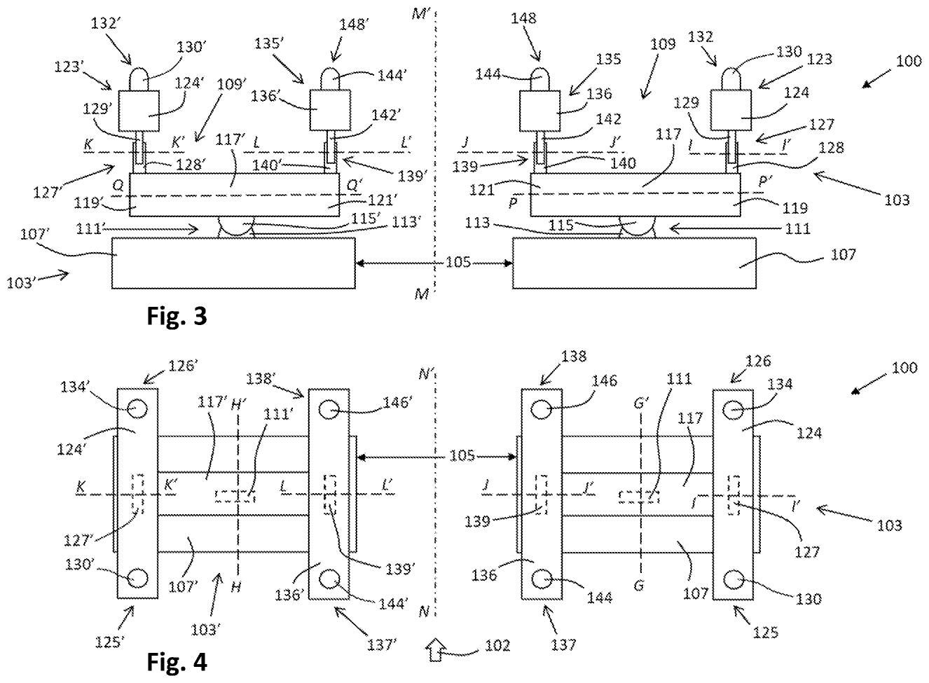

FIG. 3 shows a schematic side view representation of another support according to the first aspect of the present invention;

FIG. 4 shows a schematic plan view representation of the support shown in FIG. 3;

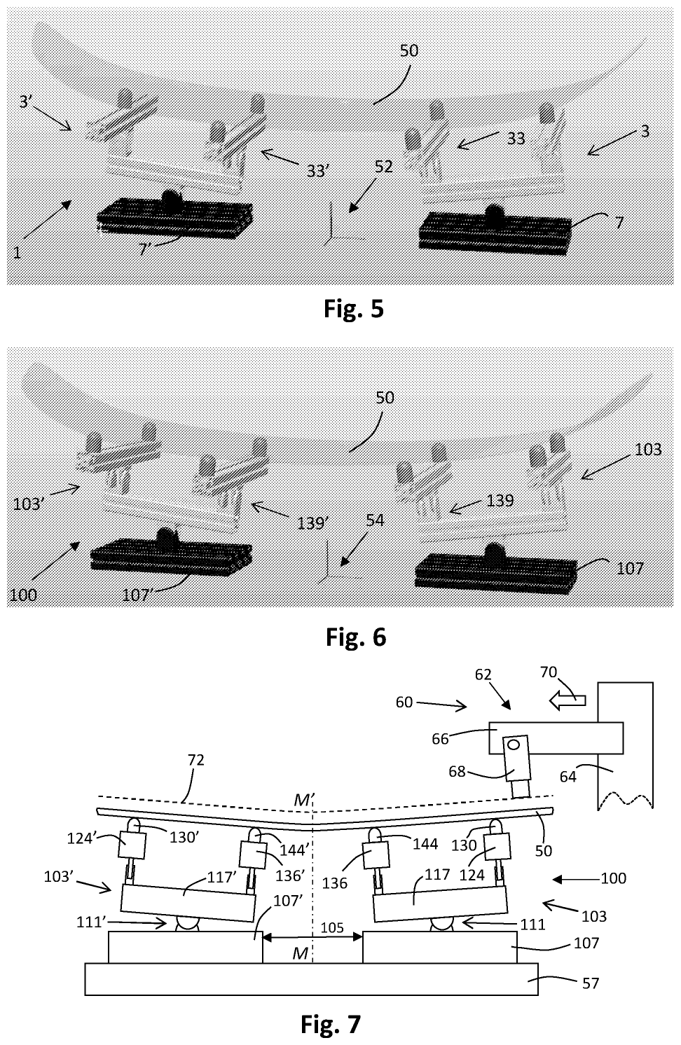

FIG. 5 shows a schematic isometric representation of the support shown in FIGS. 1 and 2 supporting a shaped sheet of glass;

FIG. 6 shows a schematic isometric representation of the support shown in FIGS. 3 and 4 supporting a shaped sheet of glass;

FIG. 7 shows a schematic side view representation of the support shown in FIGS. 3 and 4 supporting a shaped sheet of glass and having the shape thereof measured;

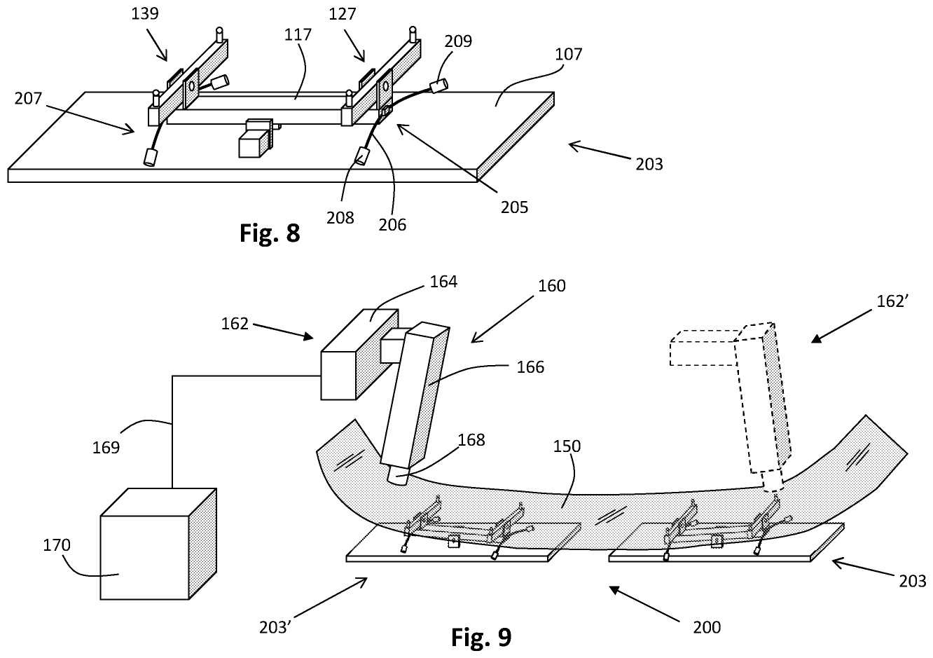

FIG. 8 shows a schematic isometric representation of a support assembly of the type shown in FIGS. 3 and 4 having dampers associated therewith;

FIG. 9 shows a schematic isometric representation of a support comprising a pair of support assemblies of the type shown in FIG. 8 shown supporting a shaped sheet of glass that is having the shape thereof measured;

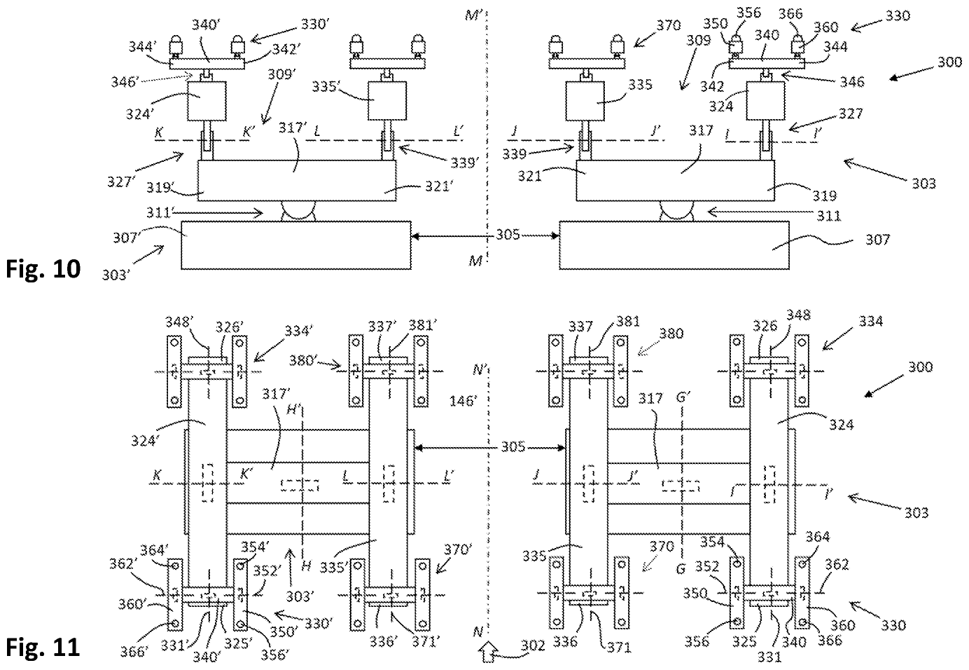

FIG. 10 shows a schematic side view representation of another support according to the first aspect of the present invention; and

FIG. 11 shows a schematic plan view representation of the support shown in FIG. 10.

FIG. 1 shows a schematic side view representation of a support 1 according to the first aspect of the present invention. FIG. 2 shows a schematic plan view representation of the support 1 shown in FIG. 1. The view of the support 1 in FIG. 1 is a view in the direction of arrow 2 in FIG. 2.

With reference to FIGS. 1 and 2, the support 1 comprises a first support assembly 3 and a second support assembly 3′.

In this example the first support assembly 3 and the second support assembly 3′ are configured the same way. In use, the support 1 is arranged with the first support assembly 3 and the second support assembly 3′ facing each such that the first support assembly 3 mirrors the second support assembly 3′.

The first support assembly 3 is spaced apart from the second support assembly 3′ by a sufficient distance 5 for supporting the particular sheet of glass on the support 1. For example, for a sheet of glass have a length L₁, to support such a sheet of glass on the support 1 the first support assembly 3 may be spaced apart from the second support assembly 3′ by a distance l₁. If a different sheet of glass having a length L₂ is to be supported on the support 1, then the first support assembly 3 may be spaced apart from the second support assembly 3′ by a distance l₂, where l₁ is not equal to l₂.

In the following description of the first and second support assemblies 3 and 3′, the equivalent part in the second support assembly 3′ is labelled with the same reference numeral as used to identify the part in the first support assembly 3 except with the addition of an apostrophe i.e. base 7 of the first support assembly 3 and base 7′ of the second support assembly 3′.

The first support assembly 3 comprises a base 7 and an arm assembly 9. The arm assembly 9 is coupled to the base 7 by a base coupling 11. The base coupling 11 is arranged such that the arm assembly 9 can rotate relative to the base 7 about a pivot axis A-A′.

The base coupling 11 comprises a first pivot mount 13 connected to the base 7 and a second pivot mount 15 connected to the arm assembly 9. A first pivot pin (not shown) couples the first pivot mount 13 to the second pivot mount 15 for rotation about the first pivot pin. The first pivot pin lies along the pivot axis A-A′. The first pivot mount 13 may be integrally formed with the base 7. The first pivot mount 13 and/or second pivot mount 15 may be configured to limit the amount of rotation of the arm assembly 9. That is, the coupling may be configured to limit the amount of rotation of the arm assembly 9 about the pivot axis A-A′. This may be useful to prevent the arm assembly 9 from hitting the base 7.

The arm assembly 9 comprises a first arm 17 being substantially elongate and having a first end 19 and a second end 21.

The first arm 17 has a longitudinal axis B-B′ and the first and second ends 19, 21 of the first arm 17 lie at opposite ends of the longitudinal axis B-B′. It is preferred that the pivot axis A-A′ is perpendicular to the longitudinal axis B-B′. In this example the pivot axis is A-A′ is perpendicular to the longitudinal axis B-B′.

The second pivot mount 15 is connected to the first arm 17 and may be integrally formed therewith.

At the first end 19 of the first arm 17, the first arm 17 has a first portion 23 extending upwardly therefrom i.e. the first portion 23 extends away from the first arm 17 in a direction away from the base 7. In this example the first portion 23 is integrally formed with the first arm 17 to form of an “L” shape having a square cross-section. In an alternative embodiment, the first portion 23 may be removably fixed to the first arm 17.

At an end of the first portion 23 is a contact pin 25. The contact pin 25 has a curved upper surface 27 for contacting a major surface of a sheet of glass to be supported on the support 1. The curved upper surface 27 is preferably configured to provide point contact with a major surface of the sheet of glass to be supported on the support 1.

At the second end 21 of the first arm 17 is a second portion 29 extending upwardly away therefrom. The second portion 29 comprises a second arm 30 having first and second ends 31, 32. The second arm 30 is an elongate bar and has an axis b-b′ running along the elongate direction thereof. In this example the axis b-b′ is parallel to the pivot axis A-A′. The elongate bar may have at least one partially hollow region and may be partially hollow i.e. tubular, or solid.

The second portion 29 is coupled to the second end 21 of the first arm 17 by a coupling 33. The coupling 33 is positioned between the first and second ends 31, 32 of the second arm 30. The coupling 33 comprises a first pivot mount 34 fixed to the second end 21 of the first arm 17 and a second pivot mount 35 connected to the second arm 30. A pivot pin (not shown) couples the first pivot mount 34 of the coupling 31 to the second pivot mount 35 of the coupling 31 for rotation about a pivot axis C-C′. In this example the pivot axis C-C′ is orthogonal to the axis b-b′.

At the first end 31 of the second arm 30 is a contact pin 37 and at the second end 32 of the second arm 30 is a contact pin 38. Each contact pin 37, 38 is configured in the same way as the contact pin 25 and have a respective curved upper surface. For example, the contact pin 37 has a curved upper surface 39 for contacting a major surface of a sheet of glass to be supported on the support 1. The contact pin 38 has a curved upper surface (not labelled) for contacting a major surface of a sheet of glass to be supported on the support 1. The curved upper surfaces of the contact pins 37, 38 are each preferably configured to provide point contact with the major surface of the sheet of glass to be supported on the support 1.

When the upper curved surfaces of the contact pins 25, 37 and 38 are arranged to make point contact with a major surface of a sheet of glass to be supported on the support 1, the point contact regions all lie in the same first plane.

In this example the pivot axis C-C′ is substantially parallel to the longitudinal axis B-B′ of the first arm 17 and aligned therewith.

In this example the pivot axis C-C′ is orthogonal to the first pivot axis A-A′.

A suitable material for making the component parts of the first support assembly 3 is aluminium because it is lightweight and is suitably strong. Other similar materials may be used. The contact pins 25, 37, 38 may be made of a different material to the rest of the frame. The contact pins 25, 37, 38 may comprise a resilient and/or soft material to contact the sheet of glass to be supported on the support 1 such that the surface of the sheet of glass is not scratched or damaged.

In the example shown in FIGS. 1 and 2, the axis A-A′ may be referred to as the first pivot axis of the first support assembly 3 and the axis C-C′ may be referred to as the second pivot axis of the first support assembly 3. The second support assembly 3′ shall now be described. As discussed above, the second support assembly 3′ is configured in the same way as the first support assembly 3 but when both first and second support assemblies 3, 3′ are used to form the support 1, the first support assembly 3 faces the second support assembly 3′ such that the second support assembly 3′ is essentially a mirror image of the first support assembly 3 about the line M-M′ of FIG. 1 and the line N-N′ of FIG. 2.

The second support assembly 3′ comprises a base 7′ and an arm assembly 9′ such that the support 1 comprises the base 7 having the arm assembly 9 coupled thereto and the base 7′ having the arm assembly 9′ coupled thereto. In an alternative embodiment to that shown in FIGS. 1 and 2, a single base is used instead of two separate bases 7, 7′. The single base may be a unitary construction or may comprise at least two connected base portions that are movable relative to one another to vary the separation of the arm assemblies 9, 9′.

The arm assembly 9′ is coupled to the base 7′ by a base coupling 11′. The coupling 11′ is arranged such that the assembly 9′ can rotate about pivot axis D-D′. The pivot axis D-D′ may be referred to as the first pivot axis of the second support assembly 3′.

The coupling 11′ comprises a first pivot mount 13′ connected to the base 7′ and a second pivot mount 15′ connected to the arm assembly 9′. A pivot pin (not shown) couples the first pivot mount 13′ to the second pivot mount 15′ for rotation about the pivot pin. The pivot pin lies along the pivot axis D-D′. The first pivot mount 13′ may be integrally formed with the base 7′. The first pivot mount 13′ and/or second pivot mount 15′ may be configured to limit the amount of rotation of the arm assembly 9′. That is, the coupling may be configured to limit the amount of rotation of the arm assembly 9 about the pivot axis D-D′. This may be useful to prevent the arm assembly 9 from hitting the base 7′.

The arm assembly 9′ comprises a first arm 17′ being substantially elongate and having a first end 19′ and a second end 21′. The first arm 17′ has a longitudinal axis E-E′ and the first and second ends 19′, 21′ of the first arm 17′ lie at opposite ends of the longitudinal axis E-E′. Preferably the longitudinal axis E-E′ is perpendicular to the pivot axis D-D′.

The second pivot mount 15′ is connected to the first arm 17′ and may be integrally formed therewith.

At the first end 19′ of the first arm 17′, the first arm 17′ has a first portion 23′ extending upwardly therefrom i.e. the first portion 23′ extends away from the first arm 17′ in a direction away from the base 7′. In this example the first portion 23′ is integrally formed with the first arm 17′. In an alternative embodiment, the portion 23′ may be removably fixed to the first arm 17′.

At an end of the first portion 23′ is a contact pin 25′. The contact pin 25′ has a curved upper surface 27′ for contacting a major surface of a sheet of glass to be supported on the support 1. The curved upper surface 27′ is preferably configured to provide point contact with the major surface of the sheet of glass to be supported on the support 1.

At the second end 21′ of the first arm 17′, the first arm 17′ has a second portion 29′ extending upwardly away therefrom. The second portion 29′ comprises a second arm having first and second ends 31′, 32′. The second arm 30′ has an elongate axis e-e′ running along the elongate direction thereof. In this example the axis e-e′ is parallel to the pivot axis D-D′.

The second portion 29′ is coupled to the second end 21′ of the first arm 17′ by a coupling 33′. The coupling 33′ is positioned between the first and second ends 31′, 32′ of the second arm 30′. The coupling 33′ comprises a first pivot mount 34′ connected to the second end 21′ of the first arm 17′ and a second pivot mount 35′ connected to the second arm 30′. A pivot pin (not shown) couples the first pivot mount 34′ of the coupling 33′ to the second pivot mount 35′ of the coupling 33′ for rotation about the pivot axis F-F′.

At the first end 31′ of the second arm 30′ is a contact pin 37′ and at the second end 32′ of the second arm 30′ is a contact pin 38′. Each contact pin 37′, 38′ is configured in the same way as the contact pin 25′ (and contact pins 25, 37, 38) and have a respective curved upper surface. The contact pin 37′ has a curved upper surface 39′ for contacting a major surface of a sheet of glass to be supported on the support 1. The contact pin 38′ has a curved upper surface (not shown) for contacting a major surface of a sheet of glass to be supported on the support 1. The curved upper surfaces of the contact pins 37′, 38′ are preferably configured to provide point contact with the major surface of the sheet of glass to be supported on the support 1.

When the upper curved surfaces of the contact pins 25′, 37′, 38′ are arranged to make point contact with a major surface of a sheet of glass to be supported on the support 1, the point contact regions all lie in the same second plane. It is preferred that the first plane of the first support assembly 3 and the second plane of the second support assembly 3′ are co-planar when no sheet of glass is supported on the support 1.

In this example the pivot axis F-F′ is substantially parallel to the longitudinal axis E-E′ of the first arm 9′ and aligned therewith.

The pivot axis F-F′ is orthogonal to the pivot axis D-D′.

A suitable material for making the component parts of the second support assembly is aluminium.

In use, the first support assembly 3 is positioned opposite the second support assembly 3′ such that the pivot axis C-C′ of the first support assembly 3 is substantially aligned with the pivot axis F-F′ of the second support assembly 3′. The spacing 5 between the first and second support assemblies 3, 3′ may be varied depending upon the size of the sheet of glass to be supported on the support 1.

In use, at least one of the couplings 33 and 33′ is preferably in a locked configuration such that the respective first pivot mount thereof is not rotatable relative to the respective second pivot mount thereof. For example, if the coupling 33 is in a locked configuration then the first pivot mount 34 is not rotatable relative to the second pivot mount 35.

When at least one of the couplings 33 and 33′ is in a locked configuration, it is preferred that the curved upper surfaces of the contact pins on the locked arm are horizontally aligned. For example, if the coupling 33 is in a locked configuration then it is preferred that the curved upper surfaces of the contact pins 37, 38 are horizontally aligned.

Also, when at least one of the couplings 33 and 33′ is in a locked configuration, it is preferred that at least one of the contact pins 37, 38, 37′, 38′ associated with the locked coupling be replaced with a respective wheel coupled to the respective second arm 30, 30′ for rotation about a respective wheel axis. It is preferred that the respective wheel axis of the wheel that replaces the respective contact pin is parallel to the pivot axis A-A′ and/or D-D′. For example, in a preferred embodiment the coupling 33 is in a locked configuration and the contact pin 37 at the first end of the second arm 30 is replaced by a first wheel coupled to the second arm 30 for rotation about a first wheel axis and the contact pin 38 at the second end of the second arm 30 is replaced by a second wheel coupled to the second arm 30 for rotation about a second wheel axis. In such embodiments it is preferred that the first and second wheel axes are parallel to the pivot axis A-A′.

In an alternative embodiment, the contact pin 25 of the first support assembly shown in FIGS. 1 and 2 may be replaced with a wheel that is coupled to the end of the first portion 23 for rotation about a first wheel axis. The wheel has an outer surface that is used to contact a major surface of a sheet of glass to be supported on the support and the outer surface of the wheel is movable relative to the first portion 23 (and hence the first arm 17). By having the first wheel axis parallel to the axis A-A′, friction between the outer surface of the wheel and the major surface of the sheet of glass being supported helps prevent movement of the sheet of glass in a direction parallel to the axis A-A′, whereas movement of the sheet of glass in a direction perpendicular to the first wheel axis is permitted because the first wheel can rotate about the first wheel axis. Such embodiments are particularly useful when the first coupling 33 is in a locked configuration.

In another alternative embodiment, the contact pin 25 of the first support assembly shown in FIGS. 1 and 2 may be replaced with a ball castor comprising a ball in a restraining fixture. The ball has an outer surface and a portion of the outer surface of the ball is used to contact a major surface of a sheet of glass to be supported on the support. The outer surface of the ball is movable relative to the first portion 23 (and hence the first arm 17).

In an alternative embodiment, the contact pin 25′ of the second support assembly shown in FIGS. 1 and 2 may be replaced with a wheel that is coupled to the end of the first portion 23′ for rotation about a first wheel axis. The wheel has an outer surface that is used to contact a major surface of a sheet of glass to be supported on the support and the outer surface of the wheel is movable relative to the first portion 23′ (and hence the first arm 17′). By having the first wheel axis parallel to the axis D-D′, friction between the outer surface of the wheel and the major surface of the sheet of glass being supported helps prevent movement of the sheet of glass in a direction parallel to the axis D-D′, whereas movement of the sheet of glass in a direction perpendicular to the first wheel axis is permitted because the first wheel can rotate about the first wheel axis. Such embodiments are particularly useful when the first coupling 33′ is in a locked configuration.

In another alternative embodiment, the contact pin 25′ of the first support assembly shown in FIGS. 1 and 2 may be replaced with a ball castor comprising a ball in a restraining fixture. The ball has an outer surface and a portion of the outer surface of the ball is used to contact a major surface of a sheet of glass to be supported on the support. The outer surface of the ball is movable relative to the first portion 23′ (and hence the first arm 17′).

In another alternative embodiment, at least one of the contact pins 37, 38 is replaced with a respective ball castor comprising a ball in a restraining fixture. Such embodiments are particularly useful in embodiments where the coupling 33′ is in a locked configuration.

In another alternative embodiment, at least one of the contact pins 37′, 38′ is replaced with a respective ball castor comprising a ball in a restraining fixture. Such embodiments are particularly useful in embodiments where the coupling 33 is in a locked configuration.

In another alternative embodiments, with reference to the arrangement as shown in FIG. 2, the first support assembly 3 is rotated 90° clockwise such that the pivot axis A-A′ is perpendicular to the line N-N′ and the second support assembly 3′ is also rotated 90° clockwise such that the pivot axis D-D′ is also perpendicular to the line N-N′. In such embodiments, the longitudinal axis B-B′ of the first arm 17 is parallel to the longitudinal axis E-E′ of the first arm 17′. Also, in such embodiments the pivot axis A-A′ is aligned with the pivot axis D-D′, or substantially parallel thereto

In another alternative embodiments, with reference to the arrangement as shown in FIG. 2, the first support assembly 3 is rotated 90° anti-clockwise such that the pivot axis A-A′ is perpendicular to the line N-N′ and the second support assembly 3′ is also rotated 90° anti-clockwise such that the pivot axis D-D′ is also perpendicular to the line N-N′. In such embodiments, the longitudinal axis B-B′ of the first arm 17 is parallel to the longitudinal axis E-E′ of the first arm 17′. Also, in such embodiments the pivot axis A-A′ is aligned with the pivot axis D-D′, or substantially parallel thereto.

In another alternative embodiments, with reference to the arrangement as shown in FIG. 2, the first support assembly 3 is rotated 90° anti-clockwise such that the pivot axis A-A′ is perpendicular to the line N-N′ and the second support assembly 3′ is rotated 90° clockwise such that the pivot axis D-D′ is also perpendicular to the line N-N′. In such embodiments, the longitudinal axis B-B′ of the first arm 17 is parallel to the longitudinal axis E-E′ of the first arm 17′. Also, in such embodiments the pivot axis A-A′ is aligned with the pivot axis D-D′, or substantially parallel thereto.

In another alternative embodiments, with reference to the arrangement as shown in FIG. 2, the first support assembly 3 is rotated 90° clockwise such that the pivot axis A-A′ is perpendicular to the line N-N′ and the second support assembly 3′ is also rotated 90° anti-clockwise such that the pivot axis D-D′ is also perpendicular to the line N-N′. In such embodiments, the longitudinal axis B-B′ of the first arm 17 is parallel to the longitudinal axis E-E′ of the first arm 17′. Also, in such embodiments the pivot axis A-A′ is aligned with the pivot axis D-D′, or substantially parallel thereto.

FIG. 3 shows a schematic side view representation of another support 100 according to the first aspect of the present invention. FIG. 4 shows a schematic plan view representation of the support 100 shown in FIG. 3. The view of the support 100 in FIG. 4 is a view in the direction of arrow 102 in FIG. 4.

With reference to FIGS. 3 and 4, the support 100 comprises a first support assembly 103 and a second support assembly 103′.

As with the previous example shown in FIGS. 1 and 2, the first support assembly 103 and the second support assembly 103′ are configured the same way. In use, the support 100 is arranged with the first support assembly 103 and the second support assembly 103′ facing each such that the first support assembly 103 mirrors the second support assembly 103′.

In the following description of the first and second support assemblies 103, 103′, the equivalent part in the second support assembly 103′ is labelled with the same reference numeral as used to identify the part in the first support assembly 103 except with the addition of an apostrophe i.e. base 107 of the first support assembly 103 and base 107′ of the second support assembly 103′.

The first support assembly 103 comprises a base 107 and an arm assembly 109. The arm assembly 109 is coupled to the base 107 by a coupling 111. The coupling 111 is arranged such that the arm assembly 109 can rotate about pivot axis G-G′.

The coupling 111 comprises a first pivot mount 113 connected to the base 107 and a second pivot mount 115 connected to the arm assembly 109. A pivot pin (not shown) couples the first pivot mount 113 to the second pivot mount 115 for rotation about the first pivot pin. The first pivot pin lies along the pivot axis G-G′. The first pivot mount 113 may be integrally formed with the base 107.

The arm assembly 109 comprises a first arm 117 being substantially elongate and having a first end 119 and a second end 121. The first arm 117 has a longitudinal axis P-P′ and the first and second ends 119, 121 of the first arm 117 lie at opposite ends of the longitudinal axis P-P′. In this example the first arm 117 is an elongate bar having a rectangular cross-section, although the elongate bar may have a different cross-section. The elongate bar may have at least one partially hollow region and may be partially hollow i.e. tubular, or solid.

The second pivot mount 115 is connected to the first arm 117 and may be integrally formed therewith.

At the first end 119 of the first arm 117, the first arm 117 has a first portion 123 extending upwardly therefrom i.e. the first portion 123 extends away from the first arm 117 in a direction away from the base 107. The first portion 123 comprises a second arm 124 having first and second ends 125, 126.

The first portion 123 is coupled to the first end 119 of the first arm 117 by a coupling 127. The coupling 127 is positioned mid-way between the first and second ends 125, 126 of the second arm 124. The coupling 127 comprises a first pivot mount 128 fixed to the first end 119 of the first arm 117 and a second pivot mount 129 connected to the second arm 124. A pivot pin (not shown) couples the first pivot mount 128 of the coupling 127 to the second pivot mount 129 of the coupling 127 for rotation about the pivot axis I-I′.

At the first end 125 of the second arm 124 is a first contact pin 130 and at the second end 126 of the second arm 124 is a second contact pin 134. Each contact pin 130, 134 has a respective curved upper surface for contacting a major surface of a sheet of glass to be supported on the support 100. In FIG. 3 the curved upper surface of the contact pin 130 is labelled with the reference numeral 132.

The curved upper surfaces of the first and second contact pins 130, 134 are preferably configured to provide point contact with the major surface of the sheet of glass to be supported on the support 100.

At the second end 121 of the first arm 117, the first arm 117 has a second portion 135 extending upwardly therefrom i.e. the second portion 135 extends away from the first arm 117 in a direction away from the base 107. The second portion 135 comprises a third arm 136 having first and second ends 137, 138. The third arm 136 is an elongate member that has an elongate axis extending between the first and second ends 137, 138.

The second portion 135 is coupled to the second end 121 of the first arm 117 by a coupling 139. The coupling 139 is positioned mid-way between the first and second ends 137, 138 of the third arm 136. The coupling 139 comprises a first pivot mount 140 connected to the second end 121 of the first arm 117 and a second pivot mount 142 connected to the third arm 136. A pivot pin (not shown) couples the first pivot mount 140 of the coupling 139 to the second pivot mount 142 of the coupling 139 for rotation about the pivot axis J-J′.

At the first end 137 of the third arm 136 is a first contact pin 144 and at the second end 138 of the third arm 136 is a second contact pin 146. Each contact pin 144, 146 has a respective curved upper surface for contacting a major surface of a sheet of glass to be supported on the support 100. The curved upper surface 148 of the first contact pin 144 is shown in FIG. 3. The curved upper surfaces of the contact pins 144, 146 are preferably configured to provide point contact with the major surface of the sheet of glass to be supported on the support 100.

With reference to FIG. 4, the first support assembly 103 is symmetrical about the axis G-G′.

The second support assembly 103′ shall now be described. As discussed above, the second support assembly 103′ is configured in the same way as the first support assembly 103 but when both first and second support assemblies 103, 103′ are used to form the support 100, the first support assembly 103 faces the second support assembly 103′ and is spaced apart therefrom by a space 105 such that the second support assembly 103′ is essentially a mirror image of the first support assembly 103 about the line M-M′ of FIG. 3 and the line N-N′ of FIG. 4.

The second support assembly 103′ comprises a base 107′ and an arm assembly 109′. The arm assembly 109′ is coupled to the base 107′ by a coupling 111′. The coupling 111′ is arranged such that the arm assembly 109′ can rotate about pivot axis H-H′.

The coupling 111′ comprises a first pivot mount 113′ connected to the base 107′ and a second pivot mount 115′ connected to the arm assembly 109′. A pivot pin (not shown) couples the first pivot mount 113′ to the second pivot mount 115′ for rotation about the first pivot pin. The first pivot pin lies along the pivot axis H-H′. The first pivot mount 113′ may be integrally formed with the base 107′.

The arm assembly 109′ comprises a first arm 117′ being substantially elongate and having a first end 119′ and a second end 121′. The first arm 117′ has a longitudinal axis Q-Q′ and the first and second ends 119′, 121′ of the first arm 117′ lie at opposite ends of the longitudinal axis Q-Q′. In this example the first arm 117′ is an elongate bar having a rectangular cross-section, although the elongate bar may have a different cross-section. The elongate bar may have at least one partially hollow region and may be partially hollow i.e. tubular, or solid.

The second pivot mount 115′ is connected to the first arm 117′ and may be integrally formed therewith.

At the first end 119′ of the first arm 117′, the first arm 117′ has a first portion 123′ extending upwardly therefrom i.e. the first portion 123′ extends away from the first arm 117′ in a direction away from the base 107′. The first portion 123′ comprises a second arm 124′ having first and second ends 125′, 126′.

The first portion 123′ is coupled to the first end 119′ of the first arm 117′ by a coupling 127′. The coupling 127′ is positioned mid-way between the first and second ends 125′, 126′ of the first arm 124′. The coupling 127′ comprises a first pivot mount 128′ fixed to the first end 119′ of the first arm 117′ and a second pivot mount 129′ connected to the second arm 124′. A pivot pin (not shown) couples the first pivot mount 128′ of the coupling 127′ to the second pivot mount 129′ of the coupling 127′ for rotation about the pivot axis K-K′.

At the first end 125′ of the second arm 124′ is a first contact pin 130′ and at the second end 126′ of the second arm 124′ is a second contact pin 134′. Each contact pin 130′, 134′ has a respective curved upper surface for contacting a major surface of a sheet of glass to be supported on the support 100. In FIG. 3 the curved upper surface of the contact pin 130′ is labelled with the reference numeral 132′.

The curved upper surfaces of the first and second contact pins 130′, 134′ are preferably configured to provide point contact with the major surface of the sheet of glass to be supported on the support 100.

At the second end 121′ of the first arm 117′, the first arm 117′ has a second portion 135′ extending upwardly therefrom i.e. the second portion 135′ extends away from the first arm 117′ in a direction away from the base 107′. The second portion 135′ comprises a third arm 136′ having first and second ends 137′, 138′.

The second portion 135′ is coupled to the second end 121′ of the first arm 117′ by a coupling 139′. The coupling 139′ is positioned mid-way between the first and second ends 137′, 138′ of the third arm 136′. The coupling 139′ comprises a first pivot mount 140′ connected to the second end 121′ of the first arm 117′ and a second pivot mount 142′ connected to the third arm 136′. A pivot pin (not shown) couples the first pivot mount 140′ of the coupling 139′ to the second pivot mount 142′ of the coupling 139′ for rotation about the pivot axis L-L′.

At the first end 137′ of the third arm 136′ is a first contact pin 144′ and at the second end 138′ of the third arm 136′ is a second contact pin 146′. Each contact pin 144′, 146′ has a respective curved upper surface for contacting a major surface of a sheet of glass to be supported on the support 100. The curved upper surface 148′ of the first contact pin 144′ is shown in FIG. 3. The curved upper surfaces of the contact pins 144′, 146′ are preferably configured to provide point contact with the major surface of the sheet of glass to be supported on the support 100.

With reference to FIG. 4, the first support assembly 103 is symmetrical about the axis H-H′.

In use, at least one of the couplings 127, 139, 127′ and 139′ is preferably in a locked configuration such that the respective first pivot mount thereof is not rotatable relative to the second pivot mount thereof. For example, if the coupling 139 is in a locked configuration then the first pivot mount 140 is not rotatable relative to the second pivot mount 142.

When at least one of the couplings 127, 139, 127′ and 139′ is in a locked configuration, it is preferred that the curved upper surfaces of the contact pins on the locked arm are horizontally aligned. For example, if the coupling 139 is in a locked configuration then it is preferred that the curved upper surfaces of the contact pins 144, 146 are horizontally aligned.

If two of the couplings 127, 139, 127′ and 139′ are in a locked configuration it is preferred that the curved upper surfaces of the contact pins on the locked arms lie in a horizontal plane.

By having at least one of the couplings 127, 139, 127′, 139′ in a locked configuration, when a sheet of glass is supported on the support 100, the sheet of glass is able to be supported thereon indefinitely. Otherwise, the sheet of glass is in a highly imbalanced arrangement and may fall off the support 100.

As is evident from FIGS. 3 and 4, the support 100 comprises the first and second support assemblies 103 and 103′. Given that each of the first and second support assemblies comprises three arms (the first support assembly 103 comprises the first arm 117, the second arm 124 and the third arm 136; and the second support assembly 103′ comprises the first arm 117′, the second arm 124′ and the third arm 136′), the support 100 comprises the six arms 117, 117′, 124, 124′, 136 and 136′. Accordingly, it is possible to define each of the arms 117, 117′, 124, 124′, 136 and 136′ in relation to the support such that the arm 117 is the first arm of the support 100, the arm 117′ is the second arm of the support 100, the arm 124 is the third arm of the support 100, the arm 136 is the fourth arm of the support 100, the arm 124′ if the fifth arm of the support 100 and the arm 136′ is the sixth arm of the support 100.

In embodiments where the coupling 127 is in a locked configuration, it is preferred that at least one of the contact pins 130, 134 be replaced with a respective wheel coupled to the respective end of the second arm 124 for rotation about a respective wheel axis. It is preferred that the respective wheel axis of the wheel that replaces the respective contact pin is parallel to the pivot axis G-G′ and/or H-H′. For example, in a preferred embodiment the coupling 127 is in a locked configuration and the contact pin 130 at the first end 125 of the second arm 124 is replaced by a first wheel coupled to the first end 125 of the second arm 124 for rotation about a first wheel axis and the contact pin 134 at the second end 126 of the second arm 124 is replaced by a second wheel coupled to the second end 126 of the second arm 124 for rotation about a second wheel axis. In such embodiments it is preferred that at least one of the first and second wheel axes is parallel to the pivot axis G-G′.

In embodiments where the coupling 139 is in a locked configuration, it is preferred that at least one of the contact pins 144, 146 be replaced with a respective wheel coupled to the respective end of the third arm 136 for rotation about a respective wheel axis. It is preferred that the respective wheel axis of the wheel that replaces the respective contact pin is parallel to the pivot axis G-G′ and/or H-H′. For example, in a preferred embodiment the coupling 139 is in a locked configuration and the contact pin 144 at the first end 137 of the third arm 136 is replaced by a first wheel coupled to the first end 137 of the third arm 136 for rotation about a first wheel axis and the contact pin 146 at the second end 138 of the third arm 136 is replaced by a second wheel coupled to the second end 138 of the third arm 136 for rotation about a second wheel axis. In such embodiments it is preferred that at least one of the first and second wheel axes is parallel to the pivot axis G-G′.

In embodiments where the coupling 127′ is in a locked configuration, it is preferred that at least one of the contact pins 130′, 134′ be replaced with a respective wheel coupled to the respective end of the second arm 124′ for rotation about a respective wheel axis. It is preferred that the respective wheel axis of the wheel that replaces the respective contact pin is parallel to the pivot axis G-G′ and/or H-H′. For example, in a preferred embodiment the coupling 127′ is in a locked configuration and the contact pin 130′ at the first end 125′ of the second arm 124′ is replaced by a first wheel coupled to the first end 125′ of the second arm 124′ for rotation about a first wheel axis and the contact pin 134′ at the second end 126′ of the second arm 124′ is replaced by a second wheel coupled to the second end 126′ of the second arm 124′ for rotation about a second wheel axis. In such embodiments it is preferred that at least one of the first and second wheel axes is parallel to the pivot axis H-H′.

In embodiments where the coupling 139′ is in a locked configuration, it is preferred that at least one of the contact pins 144′, 146′ be replaced with a respective wheel coupled to the respective end of the third arm 136′ for rotation about a respective wheel axis. It is preferred that the respective wheel axis of the wheel that replaces the respective contact pin is parallel to the pivot axis G-G′ and/or H-H′. For example, in a preferred embodiment the coupling 139′ is in a locked configuration and the contact pin 144′ at the first end 137′ of the third arm 136′ is replaced by a first wheel coupled to the first end 137′ of the third arm 136′ for rotation about a first wheel axis and the contact pin 146′ at the second end 138′ of the third arm 136′ is replaced by a second wheel coupled to the second end 138′ of the third arm 136′ for rotation about a second wheel axis. In such embodiments it is preferred that at least one of the first and second wheel axes is parallel to the pivot axis H-H′.

When at least one of the couplings 127, 139, 127′, 139′ is in a locked configuration, the couplings 127, 139, 127′, 139′ not in a locked configuration may be modified by replacing at least one of contact pins associated with an unlocked coupling with a ball castor, wherein the respective curved upper surface is provided by a portion of the surface of the ball of the respective ball castor. For example, if the coupling 127 is in a locked configuration and the coupling 139 is in an unlocked configuration so that the second arm 136 is free to rotate about the pivot axis J-J′, one or both of the contact pins 144, 146 may be replaced by a respective ball castor, where a portion of the ball of the respective ball castor provides the contact surface.

In the previously described supports 1 and 100, when one or more of the contact pins is replaced by a ball castor, the ball castor may comprise a spring in between the ball and the restraining fixture arranged such that the ball is movable in the restraining fixture upon compressing the spring. The spring functions as a damper such that when a sheet of glass is positioned on the contact surface provided by the ball of the ball castor, the spring may be compressed thereby dampening oscillation that may occur as the glass is positioned on the support.

In an alternative embodiment, with reference to the arrangement as shown in FIG. 4, the first support assembly 103 is rotated 90° clockwise such that the pivot axis G-G′ is perpendicular to the line N-N′ and the second support assembly 103′ is also rotated 90° clockwise such that the pivot axis H-H′ is also perpendicular to the line N-N′. In such embodiments, the longitudinal axis P-P′ of the first arm 117 is parallel to the longitudinal axis Q-Q′ of the first arm 117′. Also, in such embodiments the pivot axis G-G′ is aligned with the pivot axis H-H′, or substantially parallel thereto.

In another alternative embodiments, with reference to the arrangement as shown in FIG. 4, the first support assembly 103 is rotated 90° anti-clockwise such that the pivot axis G-G′ is perpendicular to the line N-N′ and the second support assembly 103′ is also rotated 90° anti-clockwise such that the pivot axis H-H′ is also perpendicular to the line N-N′. In such embodiments, the longitudinal axis P-P′ of the first arm 117 is parallel to the longitudinal axis Q-Q′ of the first arm 117′. Also, in such embodiments the pivot axis G-G′ is aligned with the pivot axis H-H′, or substantially parallel thereto.

In another alternative embodiments, with reference to the arrangement as shown in FIG. 4, the first support assembly 103 is rotated 90° anti-clockwise such that the pivot axis G-G′ is perpendicular to the line N-N′ and the second support assembly 103′ is rotated 90° clockwise such that the pivot axis H-H′ is also perpendicular to the line N-N′. In such embodiments, the longitudinal axis P-P′ of the first arm 117 is parallel to the longitudinal axis Q-Q′ of the first arm 117′. Also, in such embodiments the pivot axis G-G′ is aligned with the pivot axis H-H′, or substantially parallel thereto.

In another alternative embodiments, with reference to the arrangement as shown in FIG. 4, the first support assembly 103 is rotated 90° clockwise such that the pivot axis G-G′ is perpendicular to the line N-N′ and the second support assembly 3′ is rotated 90° anti-clockwise such that the pivot axis H-H′ is also perpendicular to the line N-N′. In such embodiments, the longitudinal axis P-P′ of the first arm 117 is parallel to the longitudinal axis Q-Q′ of the first arm 117′. Also, in such embodiments the pivot axis G-G′ is aligned with the pivot axis H-H′, or substantially parallel thereto.

FIG. 5 shows a schematic isometric representation of a shaped sheet of glass being supported on the support 1 configured as described with reference to FIGS. 1 and 2. The shaped sheet of glass (often referred to as a bent sheet of glass or a curved sheet of glass) may be curved in two orthogonal directions.

With reference to FIGS. 1, 2 and 5, the shaped sheet of glass 50 is shown supported on the support 1. The first support assembly 3 is spaced apart from the second support assembly 3′ by a spacing 5. Equidistant between the first and second support assemblies 3, 3′ lines N-N′ and M-M′ intersect with another line perpendicular to both lines N-N′ and M-M′ and is illustrated as axes 52 in FIG. 5.

The shaped sheet of glass 50 is substantially symmetrical about the lines N-N′ and M-M′ and is supported on the contact pins 25, 37, 38 of the first support assembly 3 on one side and on the contact pins 25′, 37′, 38′ of the second support assembly 3′ on the other side. Since the first and second support assemblies 3, 3′ are essentially identical but arranged to be a mirror image of one another as described above, the forces on the substantially symmetrical shaped sheet of glass 50 are quickly balanced thereby reducing any oscillations when the shaped sheet of glass 50 is placed on the support 1. Furthermore, the balanced forces provided by the support 1 makes the support able to accommodate vibrations due to other external forces. This is desirable when wanting to make shape measurements of the shaped sheet of glass as any vibrations can affect measurement accuracy and may increase the time taken to make such measurements.

In another embodiment, the first and second support assemblies 3, 3′ are each rotated 90° relative to the position shown in FIG. 5. The 90° rotation may be clockwise, or anti-clockwise, that is the first support assembly 3 may be rotated 90° clockwise and the second support assembly 3′ may be rotated 90° clockwise; or the first support assembly 3 may be rotated 90° clockwise and the second support assembly 3′ may be rotated 90° anti-clockwise; or the first support assembly 3 may be rotated 90° anti-clockwise and the second support assembly 3′ may be rotated 90° clockwise; or the first support assembly 3 may be rotated 90° anti-clockwise and the second support assembly 3′ may be rotated 90° anti-clockwise. Having the support 1 arranged this way may be useful when the sheet of glass 50 has more curvature in a direction parallel to the axis N-N′.

FIG. 6 shows a schematic isometric representation of the shaped sheet of glass 50 being supported on the support 100 configured as described with reference to FIGS. 3 and 4.

With reference to FIGS. 3, 4 and 6, the shaped sheet of glass 50 is shown supported on the support 100. The first support assembly 103 is spaced apart from the second support assembly 103′ by a spacing 105. Equidistant between the first and second support assemblies 103, 103′ lines N-N′ and M-M′ intersect with another line perpendicular to both lines N-N′ and M-M′ and is illustrated as axes 54 in FIG. 6.

In this example shown, the coupling 139 is in a locked configuration as described above and the coupling 139′ is in an unlocked configuration so that the third arm 136′ is free to rotate about the pivot axis L-L′.

The shaped sheet of glass 50 is substantially symmetrical about the lines N-N′ and M-M′ and is supported on the contact pins 125, 134, 144, 146 of the first support assembly 103 on one side and on the contact pins 125′, 134′, 144′, 146′ of the second support assembly 103′ on the other side. Since the first and second support assemblies 103, 103′ are essentially identical but arranged to be a mirror image of one another as described above, the forces on the substantially symmetrical shaped sheet of glass 50 are quickly balanced thereby reducing any oscillations when the curved sheet of glass 50 is placed on the support 100. Furthermore, the balanced forces provided by the support 100 makes the support able to accommodate vibrations due to other external forces. This is desirable when wanting to make shape measurements of the shaped sheet of glass as any vibrations can affect measurement accuracy and may increase the time taken to make such measurements.

Both the supports 1 and 100 use a whippletree (often referred to as whiffletree) arrangement to distribute forces evenly thereby providing a support for a sheet of glass that may have an increased number of contact pins to support the sheet of glass without distorting the glass shape whilst balancing forces on the contact pins to accommodate small changes in glass shape.

In an alternative embodiment the coupling 139 is in an unlocked configuration so that the third arm 136 is free to rotate about the pivot axis J-J′ and the coupling 139′ is in a locked configuration.

In another embodiment the coupling 127 is in an unlocked configuration so that the second arm 124 is free to rotate about the pivot axis I-I′ and the coupling 127′ is in a locked configuration.

In another embodiment the coupling 127 is in a locked configuration as described above and the coupling 127′ is in an unlocked configuration so that the second arm 124′ is free to rotate about the pivot axis K-K′.

In another embodiment the couplings 127 and 139 are in a locked configuration as described above, the coupling 127′ is in an unlocked configuration so that the second arm 124′ is free to rotate about the pivot axis K-K′ and the coupling 139′ is in an unlocked configuration so that the third arm 136′ is free to rotate about the pivot axis L-L′.

In another embodiment the couplings 127, 127′ and 139 are in a locked configuration as described above and the coupling 139′ is in an unlocked configuration so that the third arm 136′ is free to rotate about the pivot axis L-L′.

In another embodiment the couplings 127, 139 and 139′ are in a locked configuration as described above and the coupling 129′ is in an unlocked configuration so that the second arm 124′ is free to rotate about the pivot axis K-K′.

When the support as shown in FIGS. 1 and 2 or FIGS. 3 and 4 was used to support a shaped sheet of glass (as shown in FIGS. 5 and 6), it was found that upon placing the shaped sheet of glass on the respective support, the support oscillated for a very short time before the position of the shaped sheet of glass became essentially fixed relative to the base portions i.e. an equilibrium configuration was reached.

It was found that once the shaped sheet of glass was supported on the support, the stability thereof was improved compared to a conventional CNC support. The pivoting connections allow the support to reach an equilibrium state very quickly, for example, applying an impulse to the central portion of the bent sheet of glass as shown in FIGS. 5 and 6, it was found the amount of vibration on the lateral portions was less than 50 μm after about 0.5 seconds. Such stability is important when the sheet of glass is supported in an environment where vibrations may occur, so that the support can be used in a wider range of environments and can be used to make subsequent measurements on the supported sheet of glass quicker.

Replacing one or more of the contact pins with ball castors having a damper spring associated therewith as described above may further improve stability.

In another embodiment, the first and second support assemblies 103, 103′ are each rotated 90° relative to the position shown in FIG. 6. The 90° rotation may be clockwise, or anti-clockwise, that is the first support assembly 103 may be rotated 90° clockwise and the second support assembly 103′ may be rotated 90° clockwise; or the first support assembly 103 may be rotated 90° clockwise and the second support assembly 103′ may be rotated 90° anti-clockwise; or the first support assembly 103 may be rotated 90° anti-clockwise and the second support assembly 103′ may be rotated 90° clockwise; or the first support assembly 103 may be rotated 90° anti-clockwise and the second support assembly 103′ may be rotated 90° anti-clockwise. Having the support 100 arranged this way may be useful when the sheet of glass 50 has more curvature in a direction parallel to the axis N-N′.

FIG. 7 shows a schematic cross-section view of the support 100 supporting a shaped sheet of glass 50 thereon.

With reference to FIGS. 3, 4 and 7, the support 100 is arranged on a suitable horizontal table 57 such that the first support assembly 103 is spaced from the second support assembly 103′ by a spacing 105.

When the shaped sheet of glass 50 is supported on the support 100, the shape thereof may be measured. In this example a shape measuring apparatus 60 is used to measure the shape of the shaped sheet of glass 50 supported on the support 100.

The shape measuring apparatus 60 comprises a robot arm assembly 62 having first and second arms 64, 66 mounted for movement relative to each other. Mounted on the second arm 64 is a distance sensor 68 such as a confocal distance sensor. Other distance sensor may be used.

The robot arm assembly 62 is arranged to move the distance sensor 68 in the direction of arrow 70 to traverse a section of the shaped sheet of glass 50. The distance sensor 68 may traverse a fixed path for each measurement (for example shown as dotted line 72) so that differences between a desired shape and a measured shape can be determined. The desired shape may be in relation to a “standard sample” or a CAD representation of the shaped sheet of glass. The entire shape of the shaped sheet of glass may be measured by using different paths across the glass surface.

Other means of moving the distance sensor may be used. There may be one or more distance sensor used.

The support 1 and the support 100 both are able to dampen vibrations due to external forces and/or when the sheet of glass if position on the support.

To further reduce vibrations, one or more damper may be associated with the moving parts of the support, in particular the first and/or second support assemblies, to further reduce the amplitude of vibrations that may occur when a sheet of glass is initially placed on the support, or from a subsequent impulse causing the sheet of glass to move on the support. The damper may be any type of damper known in the art. The damper may comprise a spring and/or dashpot. A particularly useful type of damper is a mass damper such as a Stockbridge damper. FIG. 8 shows the location of two Stockbridge dampers in a support assembly as described with reference to FIGS. 3 and 4 (i.e. the support assembly 203 shown in FIG. 8 is the same construction as the first support assembly 103 except with the addition of the Stockbridge dampers 205, 207).

Each Stockbridge damper 205, 207 comprises a stranded steel cable with a suitable mass (for example a 50 g weight) at each end in mechanical communication at each of the arm 117 with the respective coupling 127, 139. For example, the Stockbridge damper 205 has a stranded steel cable 206 with 50 g weights 208, 209 at each end thereof. When the masses move up and down (or rotate) frictional energy is dissipated in the cable. The weights are arranged so that the cantilevers balance.

The support 100 may also be used to support a sheet of glass when other types of shape measurement technique are used to determine the shape of the sheet of glass, for example fringe projection based systems and contact measurement systems such as a co-ordinate measurement machine.

Also shown in FIG. 8 is a rotary damper 210 in mechanical communication with the coupling 111. The support assembly 203 may or may not comprise the rotary damper 210 as well as or instead of the Stockbridge dampers 205, 207.

FIG. 9 shows a pair of support assemblies of the type shown in FIG. 8 supporting a shaped sheet of glass 150. The sheet of glass 150 is not shaped using the support 200, but instead was previously shaped using a glass shaping process such as gravity sag bending or press bending. Shape measurements are made at ambient temperature, for example at a temperature less than 40° C.

The support 200 comprises first support assembly 203 spaced apart from a second support assembly 203′ The curved sheet of glass is supported on the support 200 and the shape thereof is shown having the shape thereof being measured using a measurement apparatus 160.

In this example the measurement apparatus 160 comprises a robotic arm assembly 162 having a first arm portion 164 coupled to a second arm portion 166. At an end of the second arm 166 a distance sensor 168 is positioned to measure the distance to the upper surface of the shaped sheet of glass 150.

The robotic arm assembly 162 and/or the distance sensor 168 is in electrical communication with a control system 170 via suitable cabling 169. The control system 170 comprises a computer running a program to control the movement of the robotic arm assembly relative to the sheet of glass being measured.

The position of the robotic arm assembly at a different measuring position is shown in phantom as 162′.

The arrangement shown in FIG. 9 is similar to that shown in FIG. 7 with the exception of the Stockbridge dampers 205, 207 associated with each support assembly 203, 203′.

The support 200 may also be used to support a sheet of glass when other types of shape measurement technique are used to determine the shape of the sheet of glass, for example fringe projection based systems and contact measurement systems such as a co-ordinate measurement machine.

FIG. 10 shows a schematic side view representation of another support 300 according to the first aspect of the present invention. FIG. 11 shows a schematic plan view representation of the support 300 shown in FIG. 10. The view of the support 300 in FIG. 10 is a view in the direction of arrow 302 in FIG. 11. The support 300 also uses a whippletree arrangement.

With reference to FIGS. 10 and 11, the support 300 comprises a first support assembly 303 and a second support assembly 303′.

As in the examples shown in FIGS. 1-4, in this example the first support assembly 303 and the second support assembly 303′ are configured the same way. In use, the support 300 is arranged with the first support assembly 303 and the second support assembly 303′ facing each such that the first support assembly 303 mirrors the second support assembly 303′.

In the following description of the first and second support assemblies 303, 303′, the equivalent part in the second support assembly 303′ is labelled with the same reference numeral as used to identify the part in the first support assembly 303 except with the addition of an apostrophe i.e. base 307 of the first support assembly 303 and base 307′ of the second support assembly 303′.

The first and second support assemblies 303, 303′ are configured in a similar way to the first and second support assemblies 103, 103′ of the support 100 shown in FIGS. 3 and 4. However, in this example, each contact pin 130, 134, 144, 146, 130′, 134′, 144′, 146′ has been replaced by a separate support sub-assembly, as will be described hereinafter.

The first support assembly 303 comprises a base 307 and an arm assembly 309. The arm assembly 309 is coupled to the base 307 by a coupling 311. The coupling 311 is arranged such that the arm assembly 309 can rotate about pivot axis G-G′.

The coupling 311 is the same as the coupling 111 previously described and comprises a first pivot mount connected to the base 307 and a second pivot mount connected to the arm assembly 309. A pivot pin (not shown) couples the first pivot mount to the second pivot mount for rotation about the first pivot pin. The first pivot pin lies along the pivot axis G-G′. The first pivot mount may be integrally formed with the base 307.

The arm assembly 309 comprises a first arm 317 being substantially elongate and having a first end 319 and a second end 321. The second pivot mount is connected to the first arm 317 and may be integrally formed therewith.

At the first end 319 of the first arm 317, the first arm 317 has a first portion extending upwardly therefrom comprising a second arm 324 having first and second ends 325, 326.

The second arm 324 is coupled to the first end 319 of the first arm 317 by a coupling 327 positioned mid-way between the first and second ends 325, 326 of the second arm 324. The coupling 327 allows the second arm 324 to rotate about the pivot axis I-I′.

At the first end 325 of the second arm 324 a first support sub-assembly 330 is coupled thereto for rotation about pivot axis 331. At the second end 326 of the second arm 324 a second support sub-assembly 334 is coupled thereto for rotation about pivot axis 348.

The pivot axis 331 is aligned with the pivot axis 348.

The pivot axis 331 is perpendicular to the pivot axis I-I′. The pivot axis 348 is also perpendicular to the pivot axis I-I′.

As will be readily apparent from the following description, the first and second support sub-assemblies 330, 333 are configured in a similar way to the support assembly 103 (or 103′).

The first support sub-assembly 330 comprises a first sub-assembly arm 340 being substantially elongate and having a first end 342 and a second end 344.

The first sub-assembly arm 340 is coupled to the first end 325 of the second arm 324 by a coupling 346 for rotation about pivot axis 331.

At the first end 342 of the first sub-assembly arm 340, a second sub-assembly arm 350 is coupled thereto for rotation about pivot axis 352. Pivot axis 352 is perpendicular to pivot axis 331.

At a first end of the second sub-assembly arm 350 is a first contact pin 354 and at a second opposite end of the second sub-assembly arm 350 is a second contact pin 356.

At a second end 344 of the first sub-assembly arm 340 a third sub-assembly arm 360 is coupled thereto for rotation about pivot axis 362. Pivot axis 362 is aligned with pivot axis 352. Pivot axis 362 is perpendicular to pivot axis 331.

The first support sub-assembly 330 is configured such that the pivot axis 352 is aligned with the pivot axis 362. The first support sub-assembly is also configured such that the pivot axis 331 is perpendicular to the pivot axis 352 and the pivot axis 362. The pivot axes 331, 348 are parallel with the pivot axis G-G′.

At a first end of the third sub-assembly arm 360 is a third contact pin 364 and at a second opposite end of the third sub-assembly arm 360 is a fourth contact pin 366.

The second support sub-assembly 334 is configured in essentially the same way as the first support sub-assembly 330, and the description of the configuration of the second support assembly is the same as the description of the configuration of the first support sub-assembly.

At the second end 321 of the first arm 317, a third arm 335 having first and second ends 336, 337 is coupled thereto for rotation by a coupling 339.

The coupling 339 positioned mid-way between the first and second ends 336, 337 of the third arm 335. The coupling 339 allows the third arm 335 to rotate about the pivot axis J-J′. The pivot axis J-J′ is aligned with the pivot axis I-I′. The pivot axis J-J′ is perpendicular to the pivot axis G-G′.

At the first end 336 of the third arm 335, a third support sub-assembly 370 is coupled thereto for rotation about pivot axis 371, and at the second end 337 of the third arm 335, a fourth support sub-assembly 380 is coupled for rotation thereto about pivot axis 381.

The pivot axis 371 is aligned with the pivot axis 381. The pivot axes 371, 381 are parallel with the pivot axis G-G′.

The third and fourth support sub-assemblies 370, 380 are configured in the same way as the first support sub-assembly 330 described above.

Each of the first, second, third and fourth support sub-assemblies is provided with four contact pins. In use, a glass sheet is at least partially supported on the contact pins of each of the first, second, third and fourth support sub-assemblies.

As previously described with reference to the examples shown in FIGS. 1-4, at least one of the contact pins described in the example shown in FIGS. 10 and 11 may be replaced with a respective wheel coupled to the respective end of the respective sub-assembly arm for rotation about a respective wheel axis.

Additionally, ball castors as previously described may be utilised with the support 300.

With reference to FIG. 11, the first support assembly 303 is symmetrical about the axis G-G′.

The second support assembly 303′ shall now be described. As discussed above, the second support assembly 103′ is configured in the same way as the first support assembly 103 but when both first and second support assemblies 303, 303′ are used to form the support 300, the first support assembly 303 faces the second support assembly 303′ and is spaced apart therefrom by a space 305 such that the second support assembly 303′ is essentially a mirror image of the first support assembly 303 about the line M-M′ of FIG. 10 and the line N-N′ of FIG. 11.

The first support assembly 303′ comprises a base 307′ and an arm assembly 309′. The arm assembly 309′ is coupled to the base 307′ by a coupling 311′. The coupling 311′ is arranged such that the arm assembly 309′ can rotate about pivot axis H-H′.

The arm assembly 309′ comprises a first arm 317′ being substantially elongate and having a first end 319′ and a second end 321′.

At the first end 319′ of the first arm 317′, the first arm 317′ has a first portion extending upwardly therefrom comprising a second arm 324′ having first and second ends 325′, 326′.

The second arm 324′ is coupled to the first end 319′ of the first arm 317′ by a coupling 327′ positioned mid-way between the first and second ends 325′, 326′ of the second arm 324′. The coupling 327′ allows the second arm 324′ to rotate about the pivot axis K-K′. The pivot axis K-K′ is perpendicular to the pivot axis H-H′.

At the first end 325′ of the second arm 324′ a first support sub-assembly 330′ is coupled thereto for rotation about pivot axis 331′. At the second end 326′ of the second arm 324′, a second support sub-assembly 334′ is coupled thereto for rotation about pivot axis 348′.

The first support sub-assembly 330′ comprises a first sub-assembly arm 340′ being substantially elongate and having a first end 342′ and a second end 344′.

The first sub-assembly arm 340′ is coupled to the second arm 324′ by a coupling 346′ for rotation about pivot axis 331′.

At the first end 342′ of the first sub-assembly arm 340′, a second sub-assembly arm 350′ is coupled thereto for rotation about pivot axis 352′.

At a first end of the second sub-assembly arm 350′ is a first contact pin 354′ and at a second opposite end of the second sub-assembly arm 350′ is a second contact pin 356′.

At the second opposite end 344′ of the first sub-assembly arm 340′ a third sub-assembly arm 360′ is coupled thereto for rotation about pivot axis 362′.

At a first end of the third sub-assembly arm 360′ is a third contact pin 364′ and at a second opposite end of the third sub-assembly arm 360′ is a fourth contact pin 366′.

The second support sub-assembly 334′ is configured in the same manner as the first support sub-assembly 330′.

At the second end 321′ of the first arm 317′, a third arm 335′ having first and second ends 336′, 337′ is coupled thereto by a coupling 339′ for rotation about pivot axis L-L′.

The coupling 339′ positioned mid-way between the first and second ends 336′, 337′ of the third arm 335′. The coupling 339′ allows the third arm 335′ to rotate about the pivot axis L-L′.

At the first end 336′ of the third arm 335′ a third support sub-assembly 370′ is coupled thereto for rotation about pivot axis 371′. At the second end 337′ of the third arm 335′ a fourth support sub-assembly 380′ is coupled thereto for rotation about pivot axis 381′.

The third and fourth support sub-assemblies 370′, 380′ are configured in essentially the same manner as the first support sub-assembly 330′.

With reference to FIG. 11, the second support assembly 303′ is symmetrical about the axis H-H′.

In use, at least one of the couplings 327, 339, 327′ and 339′ is preferably in a locked configuration such that the respective arm is not rotatable relative to the respective base.

When at least one of the couplings 327, 339, 327′ and 339′ is in a locked configuration, it is preferred that the curved upper surfaces of the contact pins on the locked arm are horizontally aligned.

If two of the couplings 327, 339, 327′ and 339′ are in a locked configuration it is preferred that the curved upper surfaces of the contact pins on the locked arms lie in a horizontal plane.

By having at least one of the couplings 327, 339, 327′, 339′ in a locked configuration, when a sheet of glass is supported on the support 300, the sheet of glass is able to be supported thereon indefinitely. Otherwise, the sheet of glass is in a highly imbalanced arrangement and may fall off the support 300.

The support 300 provides greater support to a glass sheet than the supports 1, 100 due to the addition of the support sub-assemblies 330, 334, 330′, 334′. This is particularly useful to support a thin sheet of glass, for example having a thickness less than about 2 mm, preferably between about 0.2 mm and about 1.8 mm. The additional support provided by the support sub-assemblies prevents the glass sheet from being deformed when supported on the support 300.

The support 300 may be used instead of the support 100 shown in FIG. 7 or the support 200 shown in FIG. 9.

Additional support sub-assemblies may be used in place of one or more of the contact pins of the support 300. For example, the contact pin 354 at the first end of the second sub-assembly arm 350 may be replaced by an additional support sub-assembly configured in the same way as the support sub-assembly 330. Such an additional support assembly may be coupled to the first end of the second sub-assembly arm 350 for rotation about a pivot axis being perpendicular to the pivot axis 352 and being parallel to the pivot axis 331. The dimensions of the component parts to make such an additional support sub-assembly for coupling to the first end of the second sub-assembly arm 350 will typically be scaled down compared to the dimensions of the component parts used to make the support sub-assembly 330. For example, the dimensions may be reduced by a factor 50% or more.

Although not shown in FIGS. 10 and 11, the first arm 317 may have mounted thereon a movable mass to adjust the equilibrium position of the first arm. Such a movable mass, which may be slidably mounted to the first arm 317, is useful to change the moment about the pivot axis G-G′ to adjust the equilibrium configuration of the first support assembly 303. This may be particularly useful in embodiments where the first support assembly 303 is not symmetrical about the pivot axis G-G′, either due to unintentional variation in the mass of the component parts, or by an intentional constructional variation, for example by having contact pins instead of support sub-assemblies 370, 380.

The present invention provides a support for a sheet of glass, especially a curved sheet of glass, that is able to better support the sheet of glass at multiple contact points without unduly affecting the shape of the sheet of glass to allow a better measurement of the shape of the shaped sheet of glass. Also, by using a whippletree arrangement, forces are balanced thereby providing a more uniform support for the shaped sheet of glass and the ability of the sheet of glass to reach an equilibrium configuration much faster compared to a static, rigid support. Manufacturing tolerances may result in changes to the shape of subsequent sheets of glass to be supported and such deviations in shape are also more easily accommodated using a support according to the present invention.

1. A support for a sheet of glass, the support comprising:
a first support assembly and a second support assembly;
wherein the first support assembly comprises a first base and a first arm assembly, the first arm assembly comprising a first arm having a first end and a second end opposite the first end thereof, there being at least a first contact surface at each of the first and second ends of the first arm for contacting a first major surface of the sheet of glass when the sheet of glass is supported on the support;
the first arm assembly being coupled to the first base by a first coupling for rotation about a first pivot axis, the first coupling being between the first and second ends of the first arm;
further wherein the second support assembly comprises a second base and a second arm assembly, the second arm assembly comprising a second arm having a first end and a second end opposite the first end thereof, there being at least a first contact surface at each of the first and second ends of the second arm for contacting the first major surface of the sheet of glass when the sheet of glass is supported on the support;
the second arm assembly being coupled to the second base by a second coupling for rotation about a second pivot axis; and
the second coupling being between the first and second ends of the second arm.

2. A support according to claim 1, wherein the first arm comprises a first portion extending away from the first end of the first arm, and the first contact surface at the first end of the first arm is at an end of the first portion at the end of the first arm.

3. A support according to claim 2, wherein the first portion at the first end of the first arm is fixed relative to the first arm; or wherein the first portion at the first end of the first arm is coupled to the first end of the first arm for rotation about a third pivot axis.

4. (canceled)

5. A support according to claim 2, wherein the first portion at the first end of the first arm is coupled to the first end of the first arm for rotation about a third pivot axis and wherein the third pivot axis is orthogonal to the first pivot axis and/or wherein the first support assembly is arranged relative to the second support assembly such that the third pivot axis is orthogonal to the second pivot axis; or wherein the first portion at the first end of the first arm is coupled to the first end of the first arm for rotation about a third pivot axis and wherein the coupling that couples the first portion at the first end of the first arm to first end of the first arm for rotation about the third pivot axis is locked such that rotation about the third pivot axis is prevented.

6. (canceled)

7. A support according to claim 1, wherein the first arm comprises a second portion extending away from the second end of the first arm, and the first contact surface at the second end of the first arm is at an end of the second portion at the second end of the first arm.

8. A support according to claim 7, wherein the second portion at the second end of the first arm is fixed relative to the first arm; or wherein the second portion at the second end of the first arm is coupled to the second end of the first arm for rotation about a fourth pivot axis.

9. (canceled)

10. A support according to claim 7, wherein the second portion at the second end of the first arm is coupled to the second end of the first arm for rotation about a fourth pivot axis and wherein the fourth pivot axis is orthogonal to the second pivot axis and/or wherein the first support assembly is arranged relative to the second support assembly such that the fourth pivot axis is orthogonal to the first pivot axis; or wherein the second portion at the second end of the first arm is coupled to the second end of the first arm for rotation about a fourth pivot axis and wherein the coupling that couples the second portion at the second end of the first arm to the second end of the first arm for rotation about the fourth pivot axis is locked such that rotation about the fourth pivot axis is prevented.

11. (canceled)

12. (canceled)

13. A support according to claim 1, wherein the second arm comprises a first portion extending away from the first end of the second arm, and the first contact surface at the first end of the second arm is at an end of the first portion at the first end of the second arm.

14. A support according to claim 13, wherein the first portion of the second arm is fixed relative to the second arm; or wherein the first portion at the first end of the second arm is coupled to first end of the second arm for rotation about a fifth pivot axis.

15. (canceled)

16. A support according to claim 13, wherein the first portion at the first end of the second arm is coupled to first end of the second arm for rotation about a fifth pivot axis and wherein the fifth pivot axis is orthogonal to the second pivot axis and/or wherein the first support assembly is arranged relative to the second support assembly such that the fifth pivot axis is orthogonal to the first pivot axis; or wherein the first portion at the first end of the second arm is coupled to first end of the second arm for rotation about a fifth pivot axis and wherein the coupling that couples the first portion at the first end of the second arm to the first end of the second arm is locked such that rotation about the fifth pivot axis is prevented.

17. (canceled)

18. A support according to claim 1, wherein the second arm comprises a second portion extending away from the second end of the second arm, and wherein the first contact surface at the second end of the second arm is at an end of the second portion at the second end of the second arm.

19. A support according to claim 18, wherein the second portion at the second end of the second arm is fixed relative to the second arm; or wherein the second portion at the second end of the second arm is coupled to the second end of the second arm for rotation about a sixth pivot axis.

20. (canceled)

21. A support according to claim 18, wherein the second portion at the second end of the second arm is coupled to the second end of the second arm for rotation about a sixth pivot axis and wherein the sixth pivot axis is orthogonal to the second pivot axis and/or wherein the first support assembly is arranged relative to the second support assembly such that the sixth pivot axis is orthogonal to the first pivot axis; or wherein the second portion at the second end of the second arm is coupled to the second end of the second arm for rotation about a sixth pivot axis and wherein the coupling that couples the second portion at the second end of the second arm to the second end of the second arm is locked such that rotation about the sixth pivot axis is prevented.

22. (canceled)

23. (canceled)

24. A support according to claim 1, wherein the first base and the second base are integrally formed or wherein the first base and the second base are in mechanical communication; and/or wherein the first support assembly is coupled to the second support assembly such that upon moving the first arm assembly from a first configuration to a second configuration, the second arm assembly is caused to move from a first configuration to a second configuration.

25. A support according to claim 1, wherein the first and/or second support assembly comprises a whippletree arrangement and/or wherein the support is arranged as a whippletree.

26. A support according to claim 1, wherein the first support assembly and/or the second support assembly comprises at least a first damper to reduce the time taken for the support to establish an equilibrium configuration.

27. A support according to claim 1, wherein the first contact surface at the first and/or second end of the first and/or second arm is provided (i) by a wheel suitably coupled for rotation to the respective end of the first or second arm or (ii) by a ball castor.

28. (canceled)

29. (canceled)

30. A method of determining the shape of a shaped sheet of glass comprising the steps: (a) supporting the shaped sheet of glass on a support configured according to claim 1; (b) using a shape measurement apparatus to obtain data related to the shape of the shaped sheet of glass supported on the support; and (c) using data obtained from step (b) to determine the shape of the shaped sheet of glass.

31. A method according to claim 30, wherein the shape measurement apparatus comprises at least one of a fringe projection system, a contact measurement probe and a co-ordinate measurement machine.

32. A method according to claim 30, wherein the shape measurement apparatus comprises a sensor movable relative to the shaped sheet of glass to measure the distance of the shaped sheet of glass from the sensor.

33. (canceled)

34. (canceled)

35. (canceled)
